(19) United States
(12) Patent Application Publication
(10) Pub. No.: US 2023/0394426 A1
(43) Pub. Date: Dec. 7, 2023

(54) SUPPLY CHAIN MANAGEMENT SYSTEM AND METHODS

(71) Applicant: SPA Performance Inc. d/b/a SPARXiQ, Cleveland, OH (US)

(72) Inventors: David Bauders, Cleveland, OH (US); SRINIVASA MURTHY VANAPALLI, NAPERVILLE, IL (US); Chitra Dorai, Chappaqua, NY (US)

(21) Appl. No.: 17/830,304

(22) Filed: Jun. 1, 2022

(51) Int. Cl. G06Q 10/08; G06Q 30/02; G06Q 30/06

(52) U.S. Cl. CPC G06Q 10/087; G06Q 30/0611; G06Q 30/0234; G06Q 30/0283

(57) ABSTRACT

A transaction ledger blockchain supporting multiple entities of a supply chain processing system is instantiated; in response to a change in a ledger block, an on-hand inventory for a given item identifier is determined based on a reported sales history and an inventory block including inventory metadata that describes a temporal snapshot of the on-hand inventory. A unit and cost allocation of the on-hand inventory is determined and a true acquisition cost for the given item identifier is determined. A special price agreement (SPA) cost is determined based on an SPA block that includes terms of an SPA and a rebate amount corresponding to the given item identifier is calculated based on the SPA cost and the true acquisition cost. A total rebate is determined, another inventory block is generated based on a revised inventory, and a rebate blockchain is updated based on the determined total rebate.

### BACKGROUND

The present invention relates to the electrical, electronic and computer arts, and more specifically, to computerized supply chain management systems and methods and to blockchain technology.

A Special Price Agreement (SPA) (referred to as an SPA and an agreement herein; also known in the art as a Rebate Contract, a Customer Price Agreement, a Distributor Price Agreement, and Ship and Debits) enable manufacturers/vendors, distributors, contractors, end-customers, and the like to negotiate special pricing and/or terms between supply chain participants. The SPAs can take multiple shapes/forms. In general, each SPA includes three main components: who the SPA is offered to, what is included in the SPA, and the price and/or terms (together with a corresponding eligibility period). The SPA typically defines the cost paid by a distributor for an item from a manufacturer, referred to as the SPA cost or rebated cost, and that is based on a negotiated cost that the manufacturer is willing to provide the item to a given distributor for.

Who an SPA is offered to is based, for example, on the identity of distributors (including whether the SPA covers all distributor branches, all locations, all end-customers of the distributor, and the like), identity of distributor branches (and their corresponding end-customers), the types of end-customers of the distributor (such as residential contractors, individuals, and the like), identities of the end-customers (including their ship to locations), locations of the end-customers, and the like. In certain situations, to save time and administration effort, manufacturers assign multiple distributor branches and end-customers to the same SPA.

Manufacturers can potentially extend special pricing on some or all of the stock-keeping units (SKUs) in their portfolio. The SPA may apply to the entire catalog (most generic), a portion of the manufacturer's product lines/groups (such as a group of SKUs; less generic), or a particular SKU (most specific). In addition, the SPA may follow a point-in-time SKU alignment policy or a current SKU alignment policy. The point-in-time SKU alignment policy means that the terms of the SPA that were valid on, for example, the sales order date to an end-customer are utilized to determine if an SPA cost is applicable. The current SKU alignment policy means that the present-day (such as the date of the sales order to an end-customer) criteria of the SPA (such as the current alignment of SKUs) is utilized. Pricing multipliers (such as a multiplier of 0.78) may be based off of a list price (the standard price quoted by, for example, a manufacturer/vendor) or based off of the distributor's into-stock cost (the cost paid by the distributor to bring the item into the distributor's inventory, such as US$0.10). Net prices (such as US$10.50) may be utilized for some SKUs. The item price is often the primary concern, but other terms, such as the payment terms (net 30 (N30), net 60 (N60), and the like), may be equally important. Moreover, distributors and the like may be eligible for aggregate rebates, such as volume-based rebates that are aggregated across SPAs, across both SPAs and non-SPAs transactions, and the like. (As used herein, a rebate is, for example, a partial refund of the cost of an item, such as the difference between an into-stock cost (or true acquisition cost, as described more fully below) and the SPA cost).

In an example scenario, a distributor negotiates the “cost” (the SPA or rebated cost) with, for example, a manufacturer during the SPA origination or amendment process. For example, suppose a distributor currently purchases an item having a given SKU for US$10; that is, the “into-stock cost” for the distributor's inventory is US$10. The distributor encounters an opportunity to sell one million (1M) units at US$8 (the end-customer price). The distributor may submit a request to the manufacturer to obtain a better cost for serving that opportunity. The manufacturer may respond by, for example, providing an SPA or rebated cost of US$7.50. In this example, the distributor makes a gross profit of US$0.50/unit (US$8 (the end-customer price) minus US$7.50 (the new SPA cost)). The distributor will claim a rebate of US$2.50 per unit (US$10 (into-stock cost) minus US$7.50 (SPA or rebated cost)=$2.50/unit).

### SUMMARY

Principles of the invention provide techniques for supply chain management. In one aspect, an exemplary method for processing rebates on a supply chain processing system based on a blockchain architecture includes the operations of instantiating an inventory blockchain that supports multiple entities of the supply chain processing system; determining, in response to a change in a ledger block of a transaction ledger blockchain, an on-hand inventory for a given item identifier based on a reported sales history and an inventory block comprising inventory metadata that describes a temporal snapshot of the on-hand inventory; determining a unit and cost allocation of the on-hand inventory using the inventory metadata; determining a true acquisition cost for the given item identifier based on the inventory metadata of the inventory block and the determined allocation; determining a special price agreement cost based on a special price agreement block, the special price agreement block comprising terms of a special price agreement; calculating a rebate amount corresponding to the given item identifier based on the special price agreement cost and the true acquisition cost; determining a total rebate based on the rebate amount and a sales quantity corresponding to the given item identifier; generating another inventory block based on a revised inventory; and updating a rebate blockchain based on the determined total rebate.

In one aspect, an exemplary method includes the operations of instantiating one or more transaction ledger blockchains that support multiple entities; accessing an enterprise system of one of the multiple entities to retrieve special price agreement participant data designated for blockchain entry; validating the accessed data designated for the blockchain entry; identifying a transaction ledger blockchain of the one or more transaction ledger blockchains for entry of the validated data; pre-processing the validated data, the pre-processing comprising formatting the validated data for entry in a ledger block of the identified transaction ledger blockchain with a timestamp corresponding to the accessed data; and populating the pre-processed data into the ledger block of the identified transaction ledger blockchain.

In one aspect, a non-transitory computer readable medium comprises computer executable instructions which when executed by a computer cause the computer to perform a method for processing rebates on a supply chain processing system based on a blockchain architecture, the method comprising the operations of instantiating an inventory blockchain that supports multiple entities of the supply chain processing system; determining, in response to a change in a ledger block of a transaction ledger blockchain, an on-hand inventory for a given item identifier based on a reported sales history and an inventory block comprising inventory metadata that describes a temporal snapshot of the on-hand inventory; determining a unit and cost allocation of the on-hand inventory using the inventory metadata; determining a true acquisition cost for the given item identifier based on the inventory metadata of the inventory block and the determined allocation; determining a special price agreement cost based on a special price agreement block, the special price agreement block comprising terms of a special price agreement; calculating a rebate amount corresponding to the given item identifier based on the special price agreement cost and the true acquisition cost; determining a total rebate based on the rebate amount and a sales quantity corresponding to the given item identifier; generating another inventory block based on a revised inventory; and updating a rebate blockchain based on the determined total rebate.

In one aspect, a non-transitory computer readable medium comprises computer executable instructions which when executed by a computer cause the computer to perform a method of instantiating one or more transaction ledger blockchains that support multiple entities; accessing an enterprise system of one of the multiple entities to retrieve special price agreement participant data designated for blockchain entry; validating the accessed data designated for the blockchain entry; identifying a transaction ledger blockchain of the one or more transaction ledger blockchains for entry of the validated data; pre-processing the validated data, the pre-processing comprising formatting the validated data for entry in a ledger block of the identified transaction ledger blockchain with a timestamp corresponding to the accessed data; and populating the pre-processed data into the ledger block of the identified transaction ledger blockchain.

In one aspect, an apparatus comprises a memory and at least one processor, coupled to the memory, and operative to perform a method for processing rebates on a supply chain processing system based on a blockchain architecture, the method comprising operations of instantiating an inventory blockchain that supports multiple entities of the supply chain processing system; determining, in response to a change in a ledger block of a transaction ledger blockchain, an on-hand inventory for a given item identifier based on a reported sales history and an inventory block comprising inventory metadata that describes a temporal snapshot of the on-hand inventory; determining a unit and cost allocation of the on-hand inventory using the inventory metadata; determining a true acquisition cost for the given item identifier based on the inventory metadata of the inventory block and the determined allocation; determining a special price agreement cost based on a special price agreement block, the special price agreement block comprising terms of a special price agreement; calculating a rebate amount corresponding to the given item identifier based on the special price agreement cost and the true acquisition cost; determining a total rebate based on the rebate amount and a sales quantity corresponding to the given item identifier; generating another inventory block based on a revised inventory; and updating a rebate blockchain based on the determined total rebate.

In one aspect, an apparatus comprises a memory and at least one processor, coupled to the memory, and operative to perform operations comprising instantiating one or more transaction ledger blockchains that support multiple entities; accessing an enterprise system of one of the multiple entities to retrieve special price agreement participant data designated for blockchain entry; validating the accessed data designated for the blockchain entry; identifying a transaction ledger blockchain of the one or more transaction ledger blockchains for entry of the validated data; pre-processing the validated data, the pre-processing comprising formatting the validated data for entry in a ledger block of the identified transaction ledger blockchain with a timestamp corresponding to the accessed data; and populating the pre-processed data into the ledger block of the identified transaction ledger blockchain.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated (a non-transitory computer readable medium comprising computer executable instructions which when executed by a computer cause the computer to perform the method steps disclosed). Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects. For example, one or more embodiments provide one or more of:
reduced computational resources for processing SPAs;
reduced computational resources for record-keeping;
increased security for sensitive information;
a blockchain architecture for supply chain management that enables sharing of an integrated supply chain processing platform and connects a plurality of entities that are participating in the supply chain while providing data privacy and security;
a supply chain inventory allocation and cost system for monitoring inventory and generating and/or verifying rebate claims using the blockchain architecture, including allocating inventory to the appropriate costing lot (bin);
efficient determination of the true acquisition cost of inventory using a blockchain architecture;
validation of transaction data with the SPA number on the transaction line;
protection against rewriting or altering transaction history;
ability to incorporate legacy SPAs into the blockchain supply chain management system;
reduced administration and processing costs;
reduced financial losses due to rebate miscalculations for manufacturers, distributors, and the like;
elimination of the chaos conventionally encountered in processing the SPAs and rebates;
increased sales due to existing SPAs through performance management;
expanded sales to other complimentary product lines;
improved SPA profitability and price strategy management; and
improved SPA customer engagement in planning, forecasting, marketing and incentives.

These and other features and advantages of the present invention will become apparent from the following detailed description of illustrative embodiments thereof, which is to be read in connection with the accompanying drawings.

### BRIEF DESCRIPTION OF THE DRAWINGS

FIGS. 1A and 1B illustrate an example conventional SPA, in accordance with the prior art;

FIG. 2A illustrates an example of the relationships between participants of a supply chain, in accordance with the prior art;

FIG. 2B illustrates an example of some of the communications between participants of a supply chain, in accordance with an example embodiment;

FIG. 3 is a high-level system diagram for a first example embodiment of a supply chain management system, in accordance with an example embodiment;

FIG. 4A is an overview of an example SPA, in accordance with the prior art;

FIG. 4B illustrates details of a rebate claim associated with the example SPA, in accordance with an example embodiment;

FIG. 4C is a visual representation of the state of a SPA, in accordance with an example embodiment;

FIG. 5A is a high-level system diagram for a first example embodiment of a blockchain version of the supply chain management system, in accordance with an example embodiment;

FIG. 5B illustrates the relationships of the entities of a supply chain in an example blockchain embodiment of the supply chain processing platform, in accordance with an example embodiment;

FIG. 5C is a swimlane diagram for an example supply chain scenario, in accordance with an example embodiment;

FIG. 6A is a flowchart for an example method for originating a special price agreement, in accordance with an example embodiment;

FIG. 6B is a flowchart for an example method for populating the manufacturer ledger blocks of a blockchain, in accordance with an example embodiment;

FIG. 7 is a flowchart for an example method for populating the distributor ledger blocks of a blockchain, in accordance with an example embodiment;

FIG. 8 is a flowchart for an example method for pre-processing the blockchain data of the manufacturer/vendor and the blockchain data of the distributor, in accordance with an example embodiment;

FIG. 9 is a flowchart for an example method for processing a rebate claim(s) using an inventory allocation and cost system of the blockchain embodiment of the supply chain processing platform, in accordance with an example embodiment;

FIG. 10 is a flowchart for an example method for registering a participant with the blockchain embodiment of the supply chain processing platform, in accordance with an example embodiment; and

FIG. 11 depicts a computer system that may be useful in implementing one or more aspects and/or elements of the invention, also representative of a cloud computing node according to an embodiment of the present invention.

### DETAILED DESCRIPTION

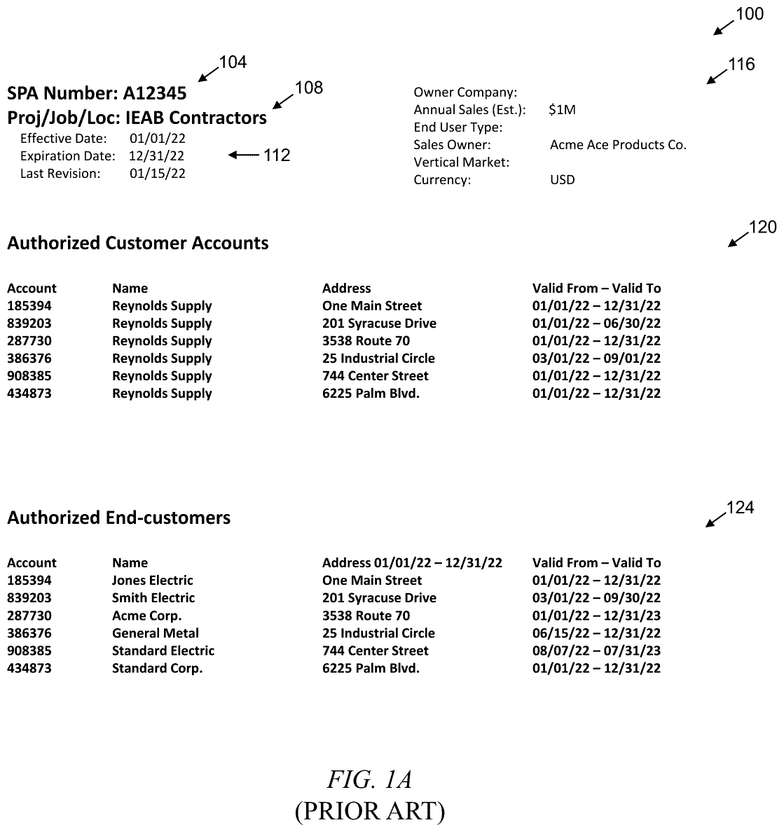

FIGS. 1A and 1B illustrate an example conventional SPA 100, in accordance with the prior art. The example SPA 100 includes an SPA identifier number 104, a project/job/location identifier 108, relevant SPA dates 112 (such as the effective time period), and business details 116 of the SPA 100. An authorized customer accounts section 120 identifies, for example, which branches of an entity are eligible for the terms of the SPA 100 and the time period during which the eligibility applies. An authorized end-users section 124 identifies, for example, which end-customers are eligible for the terms of the SPA 100 and the time period during which the eligibility applies.

Section 128 of the SPA 100 identifies groups of products (also known as product lines, product groups, product segments, and the like) identified by the manufacturer as having a special price for a particular period of time. Section 132 of the SPA 100 identifies special pricing agreements for individual SKUs, as identified by, for example, a universal product code (UPC).

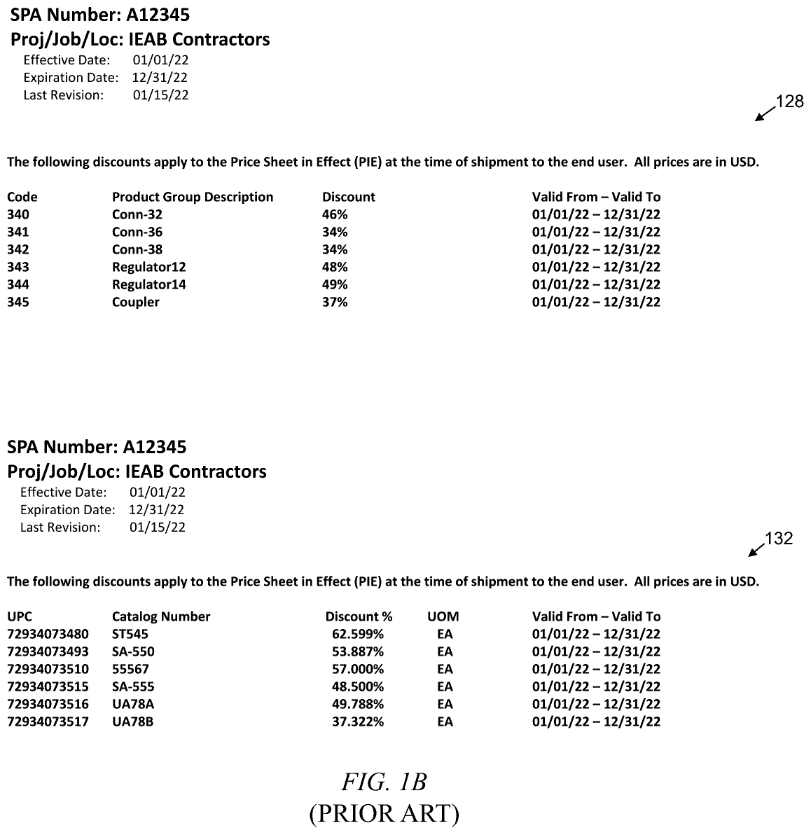

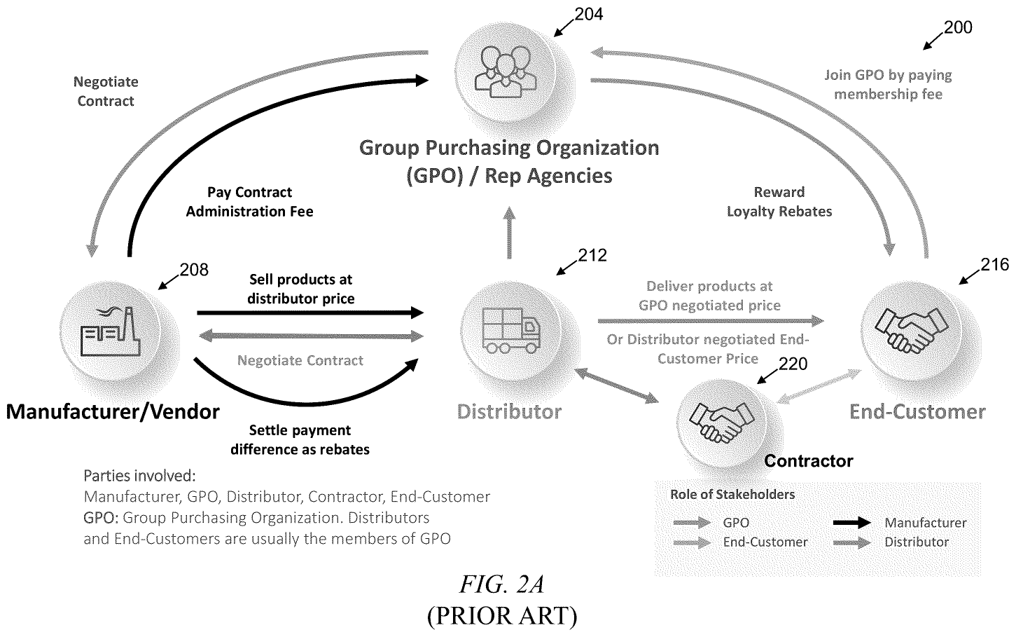

FIG. 2A illustrates an example of the relationships 200 between participants of a supply chain, in accordance with the prior art. In one example embodiment, a distributor 212 negotiates prices and/or terms with manufacturers/vendors 208 to develop the SPA. Group Purchasing Organizations (GPOs) 204 may also negotiate prices and/or terms with the manufacturers/vendors 208 on behalf of the distributors 212, end-customers 216, and the like. (It is noted that a GPO 204 may include a group of distributors 212, contractors 220, and the like who participate in a program of a group purchasing organization.) The distributor 212 then purchases the item(s) from the manufacturers/vendors 208 and ships them to the end-customers 216 based on either the GPO-negotiated SPA or the distributor-negotiated SPA, as appropriate.

The distributor 212 or the GPO 204 may claim a rebate from the manufacturer/vendor 208 based on the SPA. For example, consider an into-stock cost of $20 for a distributor 212 and an agreed SPA or rebated cost of $15 for an item sold to a customer eligible under the SPA terms; the distributor 212 will claim a settlement payment of $5 as a rebate (determined by the difference between the into-stock cost of $20 and the agreed SPA or rebated cost of $15). The claim request must be checked against the SPA dates, SKU number, product group, end-customer 216, and the like of the SPA to ensure that the claim is valid. It is noted that components of the SPA (such as who is on the SPA, what is in the SPA, the addition of new products/groups, validity dates, pricing multipliers, and the like) may also change over time, thereby complicating the rebate process. It is also noted that the Group Purchasing Organizations (GPO's) 204 will often provide a reward loyalty/volume rebate to the end-customers 216 based, for example, on the annual purchase volume, if any, received from the manufacturers/vendors 208.

Extended sales organizations and representative (rep) agencies, such as a contractual salesforce, of a manufacturer/vendor 208 handle smaller end-customers 216. The rep agencies facilitate the specification process between, for example, the distributors 212 and smaller customers of the end-customers 216, and close sales with the smaller end-customers 216. In addition, contractors 220 purchase items from distributors for and/or on behalf of the end-customers 216.

In a conventional process, a distributor 212 typically requests an SPA for one or more of its end-customers 216 and for certain SKUs, product groups, and the like. This is conventionally performed, for example, by the distributor 212 sending the request using a spreadsheet via email. The manufacturer/vendor 208 reviews and approves the SPA request, denies the SPA request, or requests more information from the distributor 212. If approved, the manufacturer/vendor 208 enters the SPA into its system and generates an SPA identification number (such as A12345, or any other alphabetical, numeric and/or alphanumeric nomenclature) that acts as a reference number during the claims process (described more fully below).

It is noted that larger manufacturers/vendors 208 often have their own internal systems, data structures, different communication methods, and the like that distributors 212 must adapt to in order to request an SPA and submit rebate claims with the necessary documentation; each manufacturer platform may conform to different standards and file specifications, making the process complex for distributors 212. The distributors 212 thus usually request SPAs and submit their rebate claims from multiple manufacturers/vendors 208 using multiple platforms. The distributors 212 typically submit their rebate claims with supporting information/documentation (such as an item identifier, an item quantity, an end-customer 216 identifier, and the like) on, for example, a monthly basis, in real-time (such as via electronic data interchange), and the like. The manufacturer/vendor 208 reviews the claims and approves the claim in full or partially, denies the claim, or requests more information. During this process, the manufacturers/vendors 208 perform checks to determine if the claim is valid. Example checks include, but are not limited to, the date of the transaction, whether a particular distributor 212 (or branch of the distributor 212) and/or end-customer 216 is eligible for the SPA, whether a particular SKU/product group is eligible, the calculated cost (using historical list price, current list price, and the like), whether a product is aligned to the right product group, whether the distributor-submitted SPA or the rebated cost matches the cost calculated using the manufacturer's system(s), and the like. Flaws in the conventional process include an inability to determine the true acquisition cost of an item (the cost of the item for, for example, the distributor 212 based on a first in (oldest in), first-out (FIFO) methodology of the distributor's inventory); a lack of an audit trail; time-consuming, resource-intense (manpower) dispute resolution; an inability to verify that a specified end-customer 216 is the true recipient of the item; and the like.

FIG. 2B illustrates an example of some of the communications between participants of a supply chain, in accordance with an example embodiment. Manufacturers/vendors 208 communicate with the distributors 212, and end-customers 216 communicate with the distributors 212 and the manufacturers/vendors 208 using a variety of modalities, leading to a chaotic supply chain management environment. For example, GPOs/Representative Agencies 204 (as seen in FIG. 2A) in the real world interact with multiple manufacturers/vendors 208, distributors 212, and end-customers 216. Distributors 212 in the real world interact with multiple manufacturers/vendors 208, GPOs 204, and end-customers 216. Distributors 212 can enter into an agreement with manufacturers/vendors 208 based on into-stock costs (defined as the cost to initially acquire the item, based, for example, on an assigned multiplier times a list price) or other parameters. (An SPA cost or rebated cost, alternatively, is the price for the item specified by the SPA and determined, for example, by multiplying an assigned multiplier times a list price, by determining a negotiated price, and the like.) End-customer 216 can enter into an agreement with the manufacturer/vendor 208 and distributors 212. It is noted that the manufacturer/vendors 208 can assign the distributor(s) 212 to a particular SPA, and distributors 212 can also enter into an SPA with a manufacturer/vendor 208 on behalf of one or more end-customers 216. At times, the distributors 212 and the manufacturers/vendors 208 pay backend rebates to the end-customers 216. Thus, conventional relationships between entities of the supply chain often prove difficult to manage and are resource-intensive. For example, human intervention in many of the supply chain tasks consumes not only manpower, but computer resources, such as computing power for executing numerous user interfaces dedicated to interfacing with individuals for human management of the supply chain.

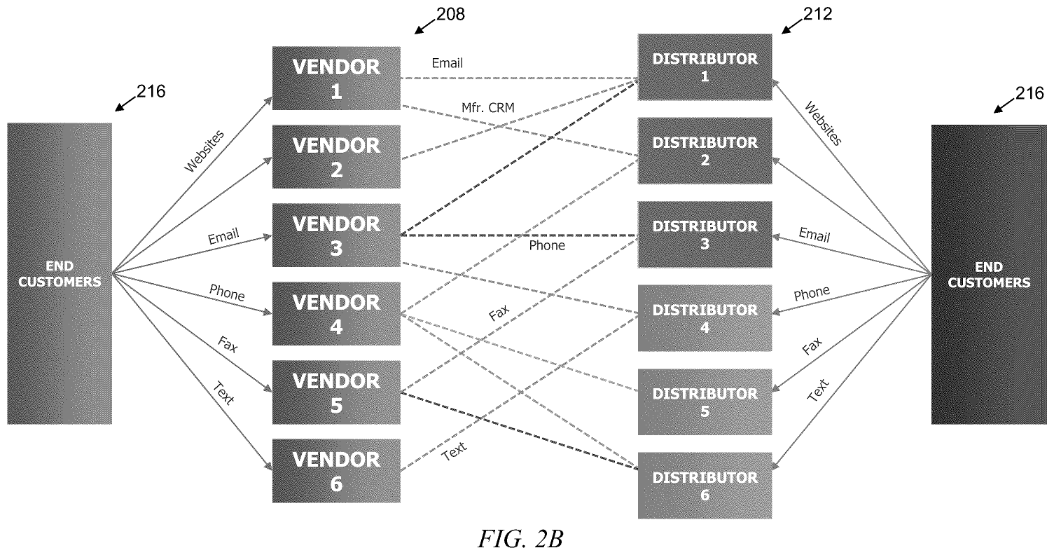

FIG. 3 is a high-level system diagram for a first example embodiment of a supply chain management system, in accordance with an example embodiment. The example embodiment provides three main areas of functionality: acquisition and renegotiation; administration (management control); and real-time reporting (performance management). Rebate requests from the distributors 212 are processed by the manufacturers/vendors 208 via a supply chain processing platform 304. The supply chain processing (SCP) platform 304 provides various services, such as aggregation, automation, analysis, augmentation, distribution with permissioning, and the like. The supply chain processing platform 304 utilizes, for example, the sales orders provided by the manufacturers/vendors 208 and the transaction histories of the distributors 212 to process rebate claims. The true acquisition cost of each item of a sale is computed by an inventory allocation and cost system of the supply chain processing platform 304 by determining the into-stock cost of each item in the distributor's inventory that is being sold, and computing the average cost of the items based on a FIFO methodology and weighted by the quantity of the item at the corresponding into-stock cost. For example, if 100 items are sold, and ten of the items were acquired with an into-stock cost of US$1.00 and 90 items were acquired with an into-stock cost of US$1.10, the true acquisition cost is US$1.09 ((10*$1.00+90*$1.10)/100=$1.09). The sale is also analyzed to determine which transactions are eligible for SPA pricing and terms, and which transactions are ineligible. It is noted that the distributors 212 and the manufacturers/vendors 208 may utilize different enterprise resource planning (ERP) systems, data structures, communication protocols, and the like, creating a complex heterogenous environment that has traditionally proven difficult to manage and lacks the technical solution to give entities rapid access to management data that is secure and trusted by the participants in the supply chain for management purposes.

The manufacturers/vendors 208 onboard all eligible distributors 212 onto the supply chain processing platform 304 (including, for example, registering and authenticating each distributor 212, ingesting distributor information, configuring the supply chain processing platform 304 for access by the registered distributors 212, and the like) and provide training on how to use the rebate system, such as the process of receiving and approving SPA requests from the distributor(s) 212, the process of submitting rebate claims and the information needed from the distributors 212 to validate the claim submissions, the process of dispute resolution, and the like. In one example embodiment, the basic data requirements of the supply chain processing platform 304 for the manufacturers/vendors 208 include:
an SKU Master with product grouping (product hierarchy), including an SKU attribute change log (captures SKU additions/deletions and describes the SKU hierarchy for a given point-in-time) and a historical list price change log (for calculating a list price at a given point-in-time);
master version of the SPA (including SPA attribute change log);
distributor sales orders (describes products, quantities, price(s) paid, and the like);
pre-processing logic (general pre-processing rules and/or logic specific to distributors 212);
a manufacturer's/vendor's part number vs. distributor part number cross-reference database;
distributor number vs. manufacturer's distributor account number cross-reference database, including a distributor location number vs. manufacturer's distributor location account number cross-reference database.

In one example embodiment, the basic data requirements of the supply chain processing platform 304 for the distributor 212 include:
rebate claims, including identification of the end-customer(s) 216, distributor number, distributor branch number, manufacturer's/vendor's catalog number, universal product code (UPC), order number, order line number, order date, invoice number, invoice line number, invoice date, quantity, standard/into-stock cost, rebate cost, SPA reference number, and rebate claim amount (per unit and/or total claim amount);
a complete sales history for all manufacturer SKUs (to support the inventory allocation and cost system) (product movement between the distributor's distribution center (DC)/branches can be included in this file or can be provided as a separate file); and on-hand inventory balance of each item at different locations.

Conventional methods for exchanging the above information include email (with, for example, spreadsheet attachments), electronic data interchange (EDI), flat files (which may need pre-processing), and the like.

Processes of the Supply Chain Processing Platform

SPA Origination

Once the supply chain processing platform 304 is configured, users, such as all onboarded distributors' authorized users, can interact with the supply chain processing platform 304 to originate an SPA request. The supply chain processing platform 304 pre-checks whether the requestor has submitted all the required/mandatory information (the system checks that all the mandatory fields are completed and performs basic data validation checks, such as confirming that the product/customer location(s) are configured in the system). The supply chain processing platform 304 notifies the manufacturers/vendors 208 about the request after performing data validation checks based on specific rules, logic, and the like, and provides a summary of items that failed the relevant business rules, if any (it is noted that the manufacturers/vendors 208 can configure their business rules and various display items on the supply chain processing platform 304). In one example embodiment, checks and data validation rules include, for example, whether there is an existing SPA for the identified combination of end-customer 216 and SKU (an overlapping SPA); whether the end-customer 216 is buying the same manufacturer's product from other distributors 212 (to identify price/channel conflicts and the like); whether the manufacturer/vendor 208 (and, potentially, the distributor 212) denied any previous agreements; whether the manufacturer/vendor 208 (and, potentially, the distributor 212) had any historical SPAs; suggested pricing derived from the manufacturer's/vendor's pricing engine; and the like.

The manufacturer/vendor 208 then approves the request, denies the request, or requests additional information via, for example, a portal of the supply chain processing platform 304. If approved, the supply chain processing platform 304 pings the manufacturer/vendor's 208 ERP platform or other SPA management platform to create an SPA (with an SPA reference number) and assign the SPA reference number on the agreement (creating a system of record). (It is noted that subsequent changes to the SPA, relevant metadata (such as when the SPA was created and where it was created), and the like are logged as well.)

If additional information was requested, the distributor 212 submits the requested information and/or additional attachments. If the request is in regard to modifying an existing or expired SPA, information regarding that SPA is submitted by the distributor 212. The manufacturer/vendor 208 then reviews the provided information/attachments, and approves the request, denies the request, or requests additional information, as necessary. If denied, the manufacturer/vendor 208 provides a reason code, descriptions, and the like to the distributor 212 (or GPO 204), and logs the same into the supply chain processing platform 304. (It is noted that an automated electronic signing mechanism, such as the DocuSign® product (registered mark of DocuSign, Inc. of San Francisco, CA, USA), may be used to execute the SPA in certain situations.)

In certain situations, the distributor 212 may request that the manufacturer/vendor 208 add additional end-customers 216, SKUs, product groups, and the like to an existing agreement and/or request price modifications to the existing agreement. Likewise, the manufacturer/vendor 208 can administer its list price and/or SKU additions and deletions on the same agreement (as opposed to creating a new agreement). These are also logged to the change log of the SPA with an identification of the changed attributes, including the new value, the source of the change, a change timestamp, IP address of the session, and the like.

Subsequent to the establishment of the SPA and the sale of the purchased items to the corresponding end-customer(s) 216, the distributor 212 submits its claims, the sales history for each of the relevant manufacturer's SKUs and on-hand inventory on a periodic basis (such as daily, weekly, monthly, and the like). The on-hand inventory is used, for example, by the inventory allocation and cost system to allocate inventory obtained by the distributor 212. As described above, rebates are considered more accurate when they are based on the true acquisition cost of a particular item that has been sold, which is often dependent on the time of purchase for the sold item, as opposed to a replacement cost. In some cases, the distributor 212 also provides its on-hand inventory instead of, or in conjunction with, a complete sales history. The supply chain processing platform 304 then combines data for the manufacturer/vendor 208 with data provided by the distributor 212, and performs any one, some or all of the following actions in the order indicated or an alternative order:
determining whether the agreement was valid on the order date;
determining whether the end-customer 216 and/or the branch of the distributor 212 is listed on the SPA for the given order date;
determining whether the SKU is covered by the SPA on the order date (if a product group is provided, the corresponding SKU or SKUs may be obtained and the validation performed);
determining the agreed-upon multiplier or net price for the SKU;
determining the list price as of the order date; and
determining the into-stock cost and/or the true acquisition cost for the distributor 212 as of the order date.

It is noted that the manufacturer/vendor part number vs. distributor part number cross-reference database may be used to determine and/or confirm the part number(s) for a particular item since, as noted above, different manufacturers/vendors 208 and distributors 212 often use different part numbers for the same item.

Inventory Allocation and Cost System Processes

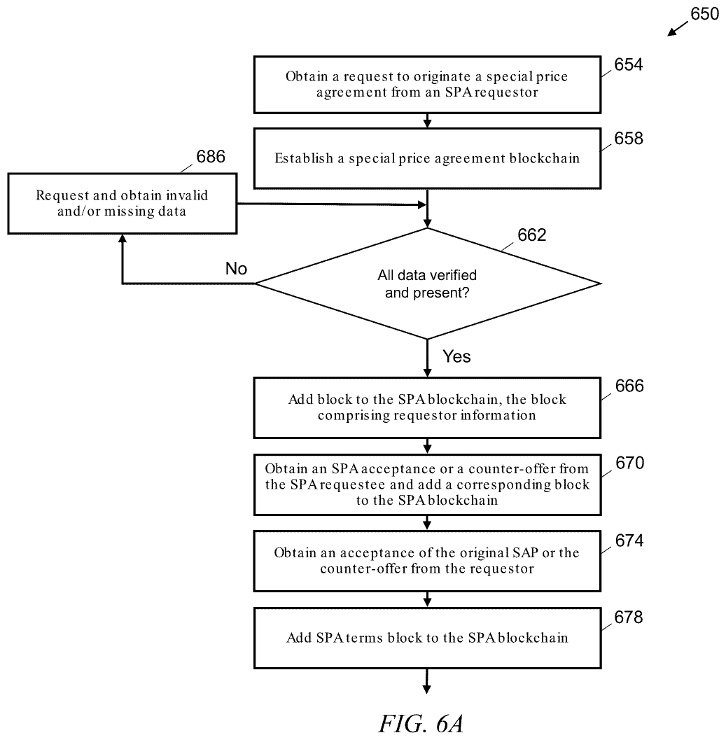

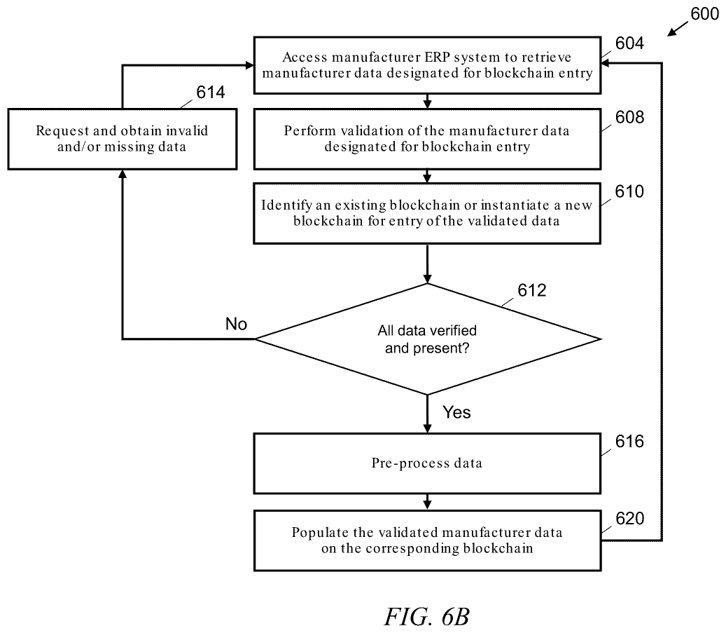

The inventory allocation and cost system in the supply chain processing platform 304 tracks and performs calculations related to the on-hand inventory for the distributor 212 of, for example, a given SKU. As described above, the distributors 212 periodically acquire inventory of a given SKU at different into-stock costs. Thus, the oldest lot (also referred to as a bin herein) of an inventory of the given SKU may have been acquired at a first into-stock cost (such as US$10), a newer lot of the inventory of the given SKU may have been acquired at a second into-stock cost (such as US$10.25), and a newest lot of the inventory of the given SKU may have been acquired at a third into-stock cost (such as US$10.50). As inventory is sold, for example, to an end-customer 216, the oldest inventory is sold first since the inventory is maintained on a first-in, first-out (FIFO) basis. Since the rebate is based on the difference between the into-stock cost of the sold item and the SPA or rebated cost specified for the item in the SPA (the SPA or rebated cost), the supply chain processing platform 304 tracks the inventory to utilize the appropriate into-stock cost of the item as each item is sold. (In one or more embodiments, the inventory allocation and cost system is implemented by programming the logic in the flow charts of FIGS. 6B-9 in a high-level programming language and compiling or interpreting it into computer-executable code, and then executing same on one or more computer processors.)

In one example embodiment, the processing by the supply chain processing platform 304 includes an identification of the branch of the distributor 212 and location of the branch based on the sales history provided by the distributor 212. The calculated data, including the on-hand inventory and cost history, is merged with the purchase orders of the manufacturer/vendor 208 and sales orders to the distributor 212 to allocate the inventory based on the first in (oldest in), first-out (FIFO) methodology. If deviations, such as a mismatch between the expected inventory and the on-hand inventory, are detected, the deviations are reported via the supply chain processing platform 304. If the detected deviations necessitate aborting the inventory allocation and cost process, the process is ended and reported via the supply chain processing platform 304; otherwise, the true acquisition cost of the relevant inventory is determined (for example, the relevant multiplier is applied to the list price at the time of acquisition to arrive at the true acquisition cost for the distributor 212, as determined based on the cost history and SPA). The rebate amount per unit (into-stock cost minus the SPA or rebated cost) is calculated and matched against the claim of the distributor 212. This is then extended to the quantity sold. Any differences between the claim and the calculated rebate are reported, including a showing of the calculation steps. In one example embodiment, the report is provided to the manufacturer/vendor 208 and the distributor 212.

Process Without an Inventory Allocation and Cost System

In situations where the inventory allocation and cost system is not available or otherwise not utilized to determine the true acquisition cost of a unit, the rebate amount per unit (current into-stock cost minus the SPA or rebated cost) is calculated and matched against the claim of the distributor 212. (It is noted that the current into-stock cost is also known as the replacement cost and the present-day cost.) This is then extended to the quantity sold. Any differences between the claim and the calculated rebate are reported, including a showing of the calculation steps. In one example embodiment, the report is provided to the manufacturer/vendor 208 and the distributor 212.

Dispute Resolution

The supply chain processing platform 304 provides the ability to resolve disputes in the rebate approval process by raising a ticket against the rebate claim and notifies the involved supply chain participants (such as the manufacturer/vendor 208 and the distributor 212). The distributor 212 provides justification for the claim using supporting documentation. The manufacturer/vendor 208 reviews the dispute and the accompanying information, and approves or denies the dispute. If needed, additional rules are added to the rules engine to address dispute requests and the like.

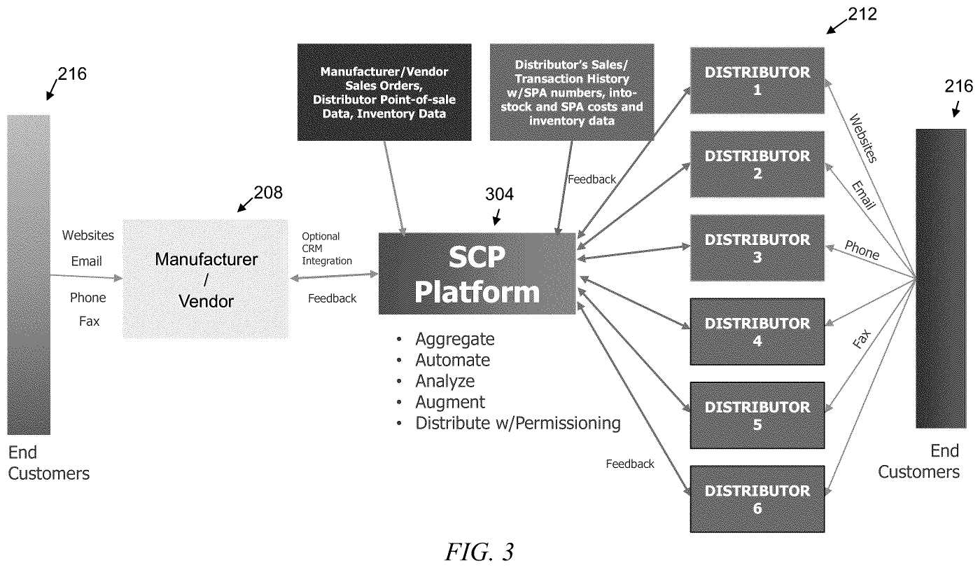

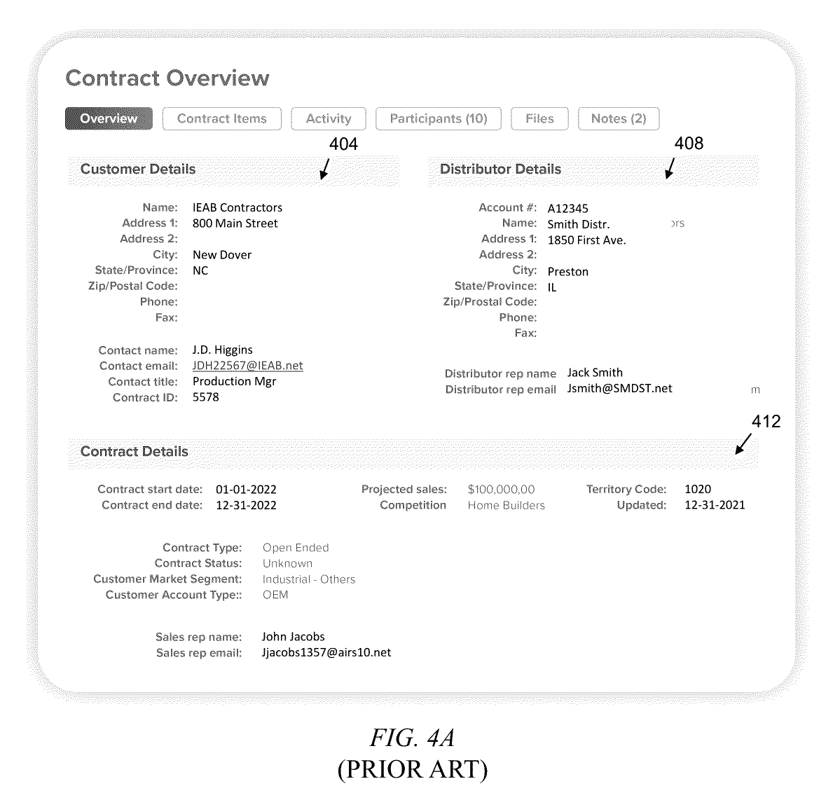

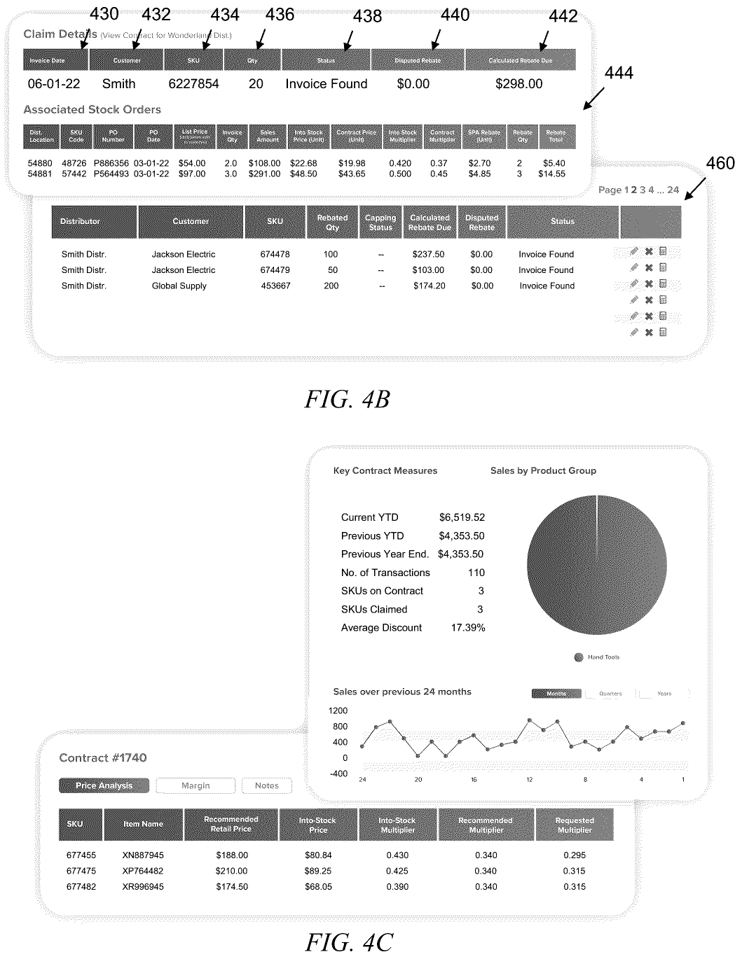

FIG. 4A is an overview of an example SPA, in accordance with the prior art. The overview includes end-customer details 404, distributor details 408, and SPA (contract) details 412. In this context, the end-customer 404 can be a contractor 220, a retail customer, an industrial customer (such as another manufacturer who utilizes the item in a product or for a service), and the like; and the distributor 212 is the distributor or similar entity who is initiating the SPA request. Important items in the SPA include the SPA (contract) type and SPA (contract) start date and end date. FIG. 4B illustrates details of a rebate claim associated with the example SPA, in accordance with an example embodiment. The claim details include, for example, an invoice date 430, customer name 432, item SKU number 434, item quantity 436, status 438, amount of a disputed rebate 440, if any, and the calculated rebate due 442. The associated stock orders table 444 contains information needed by the inventory allocation and cost system to determine the true acquisition cost and the appropriate rebate amount. Table 460 summarizes the disputed rebates 440 and the calculated rebate amount due 442 for a number of invoices. FIG. 4C is a visual representation of the state of an SPA, in accordance with an example embodiment.

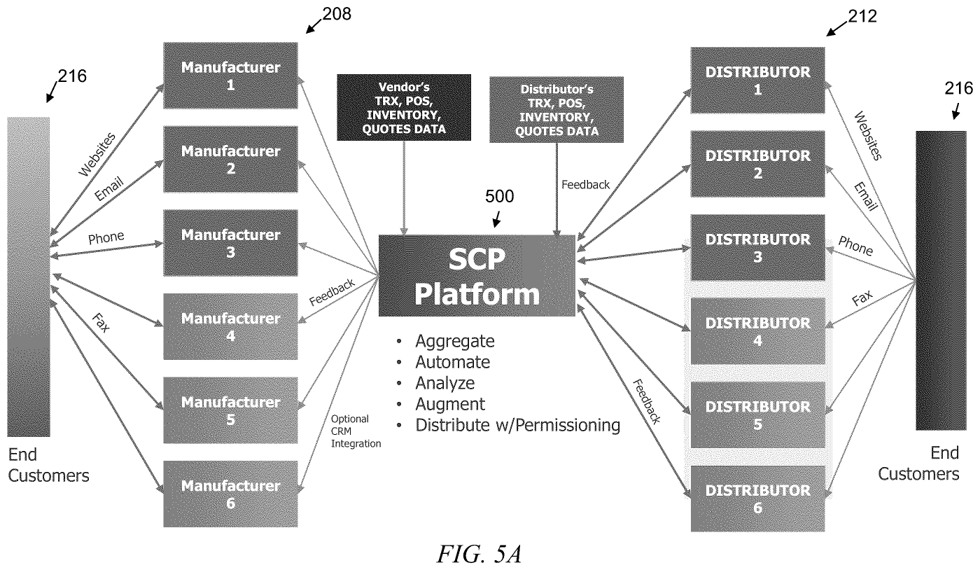

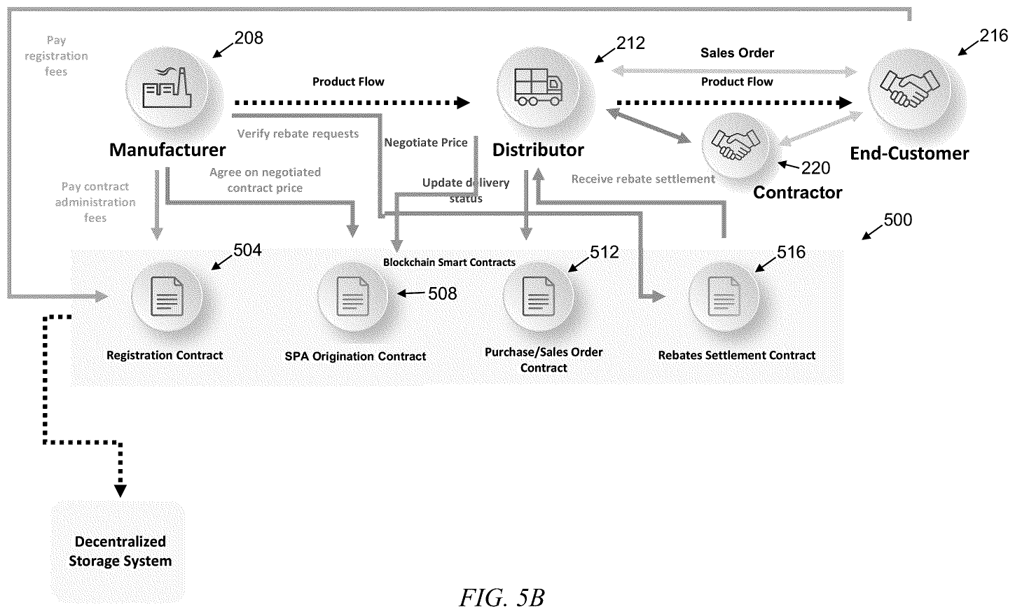

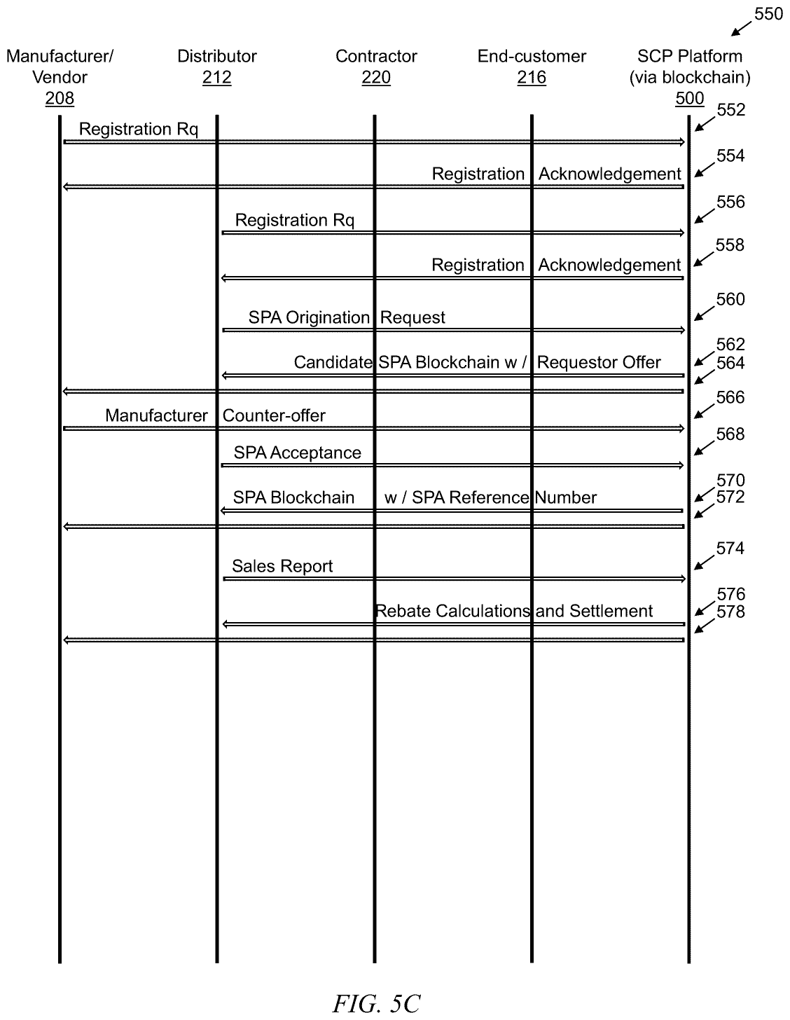

FIG. 5A is a high-level system diagram for a first example embodiment of a blockchain version of the supply chain management system connecting a plurality of manufacturers and distributors, in accordance with an example embodiment. Rebate requests from the distributors 212 are processed by the manufacturers/vendors 208 via a supply chain processing platform 500. As with the supply chain processing platform 304, the supply chain processing platform 500 provides various services, such as aggregation, automation, analysis, augmentation, distribution with permissioning, and the like. As noted above, the distributors 212 and the manufacturers/vendors 208 conventionally utilize different enterprise resource planning (ERP) systems, disparate data structures (including different sets of SKUs, part numbers and the like), different communication methods, competing interests, and the like, creating a complex heterogenous environment that has traditionally proven difficult to manage due, in part, to a lack of trust (due to security, privacy, antitrust issues, and the like) in shared platforms (platforms shared by different enterprises and, potentially, shared by competitors) and disparate data structures. In general, conventional shared platforms lack the technical solution to give entities rapid access to management data that is secure and trusted by the participants in the supply chain for management purposes. The exclusion of shared platforms for supply chain processing leads to inefficient use of computing resources and increased processing time to, for example, process bills of material. For example, multiple platforms may need to be accessed to process a bill of material that includes items from different manufacturers; multiple workflows need to be supported, requiring users to learn the protocols of a variety of workflows. The architecture described above addresses the security, privacy, and antitrust issues noted above, enables the support of a plurality of manufacturers/vendors 208 and other supply chain participants on an integrated platform, and reduces the computer resources and processing time for managing supply chains and, for example, the rebate process.

The supply chain processing platform 500 utilizes a blockchain architecture that is secure and trusted by the participants of the supply chain and, for example, automatically generates trusted accurate rebate calculations using a blockchain-compatible inventory allocation and cost system. It provides a single set of workflows for use by a variety of entities, including entities in competitive relationships. The supply chain processing platform 500 utilizes blockchain executables (known as “chaincode” and smart contracts) that operate on the blocks of the blockchain and the data of the blocks to provide an array of functionality to the blockchain environment (chaincode and smart contracts are computerized, code-implemented logic agreed upon by participants of the SCP platform 500). To enable use of a blockchain architecture, in one example embodiment, the purchase/sales order computerized, code-implemented contract 512 parses submitted information, such as a purchase order, a sales order, a bill of material, and the like (that includes items purchased from a plurality of manufacturers/vendors 208) and segregates the information by manufacturer, as part of a pre-processing operation, to prepare the information for entry into the appropriate ledger blocks of the appropriate blockchain(s) thereby providing the security and privacy demanded by the participants of the supply chain management system and enabling the determination of the true acquisition cost needed for rebate processing. (Given the teachings herein, the skilled artisan will be able to implement a suitable parser using languages such as Python or Perl.)

As described above, the distributor ledger data may be added to the blockchain corresponding to the SPA covering the items of the sales report (the SPA blockchain), to a blockchain dedicated to the distributor 212, to a blockchain of the corresponding manufacturer/vendor 208, and the like. In any case, distributor ledger data corresponding to different manufacturers/vendors 208 are segregated by manufacturer/vendor and stored in separate blocks, and potentially separate chains of blocks, from distributor ledger data corresponding to other manufacturers/vendors 208.

The transition to a blockchain architecture also introduces other technical issues in comparison to a conventional database architecture. While the data in a chain of blocks is immutable and thereby provides a certain level of trust, the immutability leads to a growing number of blocks in the chain of blocks, and thus locating the information required to, for example, process a rebate claim can prove challenging. Thus, it will be appreciated that technical problems arise when seeking to use blockchain. In one example embodiment, the introduction of an inventory blockchain overcomes the technical problem posed by the immutability of the data, advantageously providing a snapshot of the current inventory level of the distributor 212, enabling easy access to the required information. As purchase orders are pre-processed, the snapshot is updated to depict the existing inventory with the addition of the purchased items, identified by purchase date, quantity and into-stock cost(s). As sales orders are pre-processed, the snapshot is updated to depict the existing inventory with the deletion of the sold items, identified by sales date and quantity (the SPA price, that is, the end-customer 216 price may also be included). The rebates settlement computerized, code-implemented contract 516 (see discussion of FIG. 5B below) uses a FIFO methodology to adjust the quantity of each bin, where each bin corresponds to a particular into-stock cost, such that the rebates settlement computerized, code-implemented contract 516 can determine the true acquisition cost as items are sold. The snapshots of the current inventory level of the inventory are stored in inventory blocks. The inventory blocks are indexed by a combination of manufacturer/vendor 208, distributor 212, and item identifier (such as SKU) for easy access to and determination of the into-stock cost and the true acquisition cost. The inventory blocks may be maintained in an inventory blockchain, in the distributor blockchain, in the blockchain of the corresponding SPA, and the like.

To provide support for legacy supply chain information (such as inventory levels and legacy SPAs), in one example embodiment, the information needed by the inventory allocation and cost system, as described more fully above, is imported into the supply chain processing platform 500 as part of a legacy data importation process compatible with a blockchain architecture. For example, the SPA origination computerized, code-implemented contract 508 or the rebates settlement computerized, code-implemented contract 516 may be tasked with obtaining the current state of the inventory (including, for example, SKUs, corresponding quantities, and corresponding into-stock costs). This information may be obtained directly from the distributor 212, or generated by the SPA origination computerized, code-implemented contract 508 or the rebates settlement computerized, code-implemented contract 516 based on purchase and sales information provided by the distributor 212 and/or the manufacturer/vendor 208.

FIG. 5B illustrates the relationships of the entities of a supply chain in an example blockchain embodiment of the supply chain processing (SCP) platform 500. A blockchain is a distributed shared ledger of data records which records transactions between participants in a network and protects against tampering of, access to, and modification of the data of the ledger. Data records in the form of cryptographic hash-linked blocks may be sequentially added to the ledger in the blockchain, maintaining a history of transactions that take place between the participants. Each block contains a timestamp for the data added to the blockchain and information to link the block to a previous block. The blockchain thus acts as a single source of truth, and participants in a blockchain network can view only those transactions that are relevant to them or that they are otherwise authorized to access. In addition, blockchain executables (known as “chaincode” and smart contracts) operate on the blocks of the blockchain and the data of the blocks to provide an array of functionality to the blockchain environment. Chaincode and smart contracts are computerized, code-implemented logic agreed upon by participants of the SCP platform 500.

In general, blockchain is peer-to-peer and may be permissionless or permissioned. Permissionless blockchain allows any user to add new transactions to the blockchain, verify transactions, and add new blocks to the blockchain. Permissioned blockchain allows only authorized users to add new transactions to the blockchain, verify transactions, and add new blocks to the blockchain.

The blockchain typically resides across a distributed network of users and computers and serves as a private or public ledger of transactions, where each transaction is authenticated by the peers of the network. In the example embodiment of FIG. 5B, smart contracts administer record-keeping and data processing for, for example, the rebate process of the supply chain. A registration smart contract 504, which is a computerized, code-implemented program or business logic (also referred to as chaincode) enables the GPOs 204 (not shown in order to avoid clutter in FIG. 5B), the manufacturers/vendors 208, the distributors 212, the end-customers 216, the contractors 220, and the like to register for participation in the processes of the supply chain, including the rebate process. The registration computerized, code-implemented contract 504 utilizes a peer-to-peer authentication technique, where only authenticated entities are allowed to participate in use of the blockchain(s) that corresponds to the registration computerized, code-implemented contract 504. In one example embodiment, the registration of an entity, such as the manufacturers/vendors 208 and the distributors 212, signifies acceptance of the terms and conditions for participation on the blockchain supply chain processing platform 500 and entry into a global directory of participants. For some supply chain participants, directories are not global; instead, a proper subset of participants are entered into a private directory to create a “walled-off” platform for conducting the tasks of the supply chain processing platform 500 by the proper subset of participants. In one example embodiment, approval of at least some of the participants of the supply chain processing platform 500 is needed to allow a registered participant or a candidate participant to register and/or participate in a “walled-off” platform.

An SPA origination computerized, code-implemented contract 508 enables the GPOs 204, the manufacturers/vendors 208, the distributors 212, the end-customers 216, the contractors 220, and the like, to originate (initially establish) and negotiate a new SPA, and renegotiate or otherwise amend an existing SPA. In one example embodiment, to originate an SPA request, an entity, such as the distributor 212, submits a request to the blockchain version of the supply chain processing platform 500 via the SPA origination computerized, code-implemented contract 508. A new blockchain is established for this SPA by the SPA origination computerized, code-implemented contract 508. In one example embodiment, a blockchain is established for each SPA. In one example embodiment, a blockchain may support multiple SPAs and a new SPA can be added to an existing blockchain, which may be identified by an identifier of an existing SPA of the blockchain or by another blockchain identifier. The SPA request includes a subset of the end-customer details 404, distributor details 408, and SPA (contract) details 412, as defined by the SPA origination computerized, code-implemented contract 508. For example, the SPA request may include: the requested time period(s) (which may correspond to the whole SPA, to particular SKUs or product groups, to particular end-customers 216, and the like); the item identifier(s) (such as a SKU, UPC, and the like); the terms (such as N30, N60, and the like); and so on. In some cases, the requestor provides guidance on the terms, such as the item price and volume discounts, which are requested. In other cases, no guidance is provided, and the manufacturer responds with the terms, such as the item price and volume discounts, which are acceptable to the manufacturer.

The SPA origination computerized code-implemented contract 508 pre-checks whether the requestor has submitted all the required/mandatory information (the system checks that all the mandatory fields are completed and performs basic checks and validation of the information). If the request passes the pre-checks, a block is added to the corresponding blockchain with the requestor information. The relevant manufacturer/vendor 208 receives the request and associated information via the SPA origination computerized, code-implemented contract 508 and performs various checks and validation on the request. In one example embodiment, the manufacturer/vendor 208 provides a summary of items that failed the relevant business rules, if any, via the SPA origination computerized, code-implemented contract 508 and a new block of the blockchain. The requestor can then retrieve the summary via the SPA origination computerized, code-implemented contract 508, and provide the supplemental information via the SPA origination computerized, code-implemented contract 508 and a new block of the blockchain.

In one example embodiment, the checks performed by or on behalf of the manufacturer/vendor 208 (such as by the SPA origination computerized, code-implemented contract 508) include, for example, whether there is an existing SPA for the identified combination of end-customer 216 and SKU (an overlapping SPA); whether the end-customer 216 is buying the same manufacturer's product from other distributors 212 (to identify price/channel conflicts and the like); whether the manufacturer/vendor 208 (and, potentially, the distributor 212) denied any previous agreements; whether the manufacturer/vendor 208 (and, potentially, the distributor 212) had any historical SPAs; suggested pricing derived from the manufacturer's/vendor's pricing engine; and the like.

The manufacturer/vendor 208 then approves the SPA request, denies the SPA request, or requests additional information via the SPA origination computerized, code-implemented contract 508, which adds a corresponding block to the blockchain. In addition, negotiations regarding the terms of the SPA may be conducted between, for example, the manufacturer/vendor 208 and the distributor 212 by iteratively exchanging proposed terms via blocks of the blockchain. If approved, the SPA origination computerized, code-implemented contract 508 creates a block that includes the SPA (with an SPA reference number) and assigns the SPA reference number on the agreement (creating a system of record). (It is noted that subsequent changes to the SPA may be negotiated and logged via the SPA origination computerized, code-implemented contract 508 and the corresponding blockchain as well.)

If additional information was requested via the blockchain, the distributor 212 submits the requested information and/or additional attachments as a response via the SPA origination computerized, code-implemented contract 508. The manufacturer/vendor 208 then reviews the provided information/attachments obtained from the SPA origination computerized, code-implemented contract 508 via the blockchain, and approves the request, denies the request, or requests additional information, as necessary. If denied, the manufacturer/vendor 208 provides a reason code, descriptions, and the like to the requestor (such as the distributor 212, the GPO 204, and the like) via the blockchain.

In certain situations, the distributor 212 may request that the manufacturer/vendor 208 add additional end-customers 216, SKUs, product groups, and the like to an existing agreement, may request price modifications to the existing agreement, and the like. Likewise, the manufacturer/vendor 208 can administer its list price and/or SKU additions and deletions on the same agreement (as opposed to creating a new agreement). These changes are also logged to the blockchain by the SPA origination computerized, code-implemented contract 508. It is noted that, in one example embodiment, the SPA origination computerized, code-implemented contract 508 and other contract entities are implemented as smart contracts using chaincode.

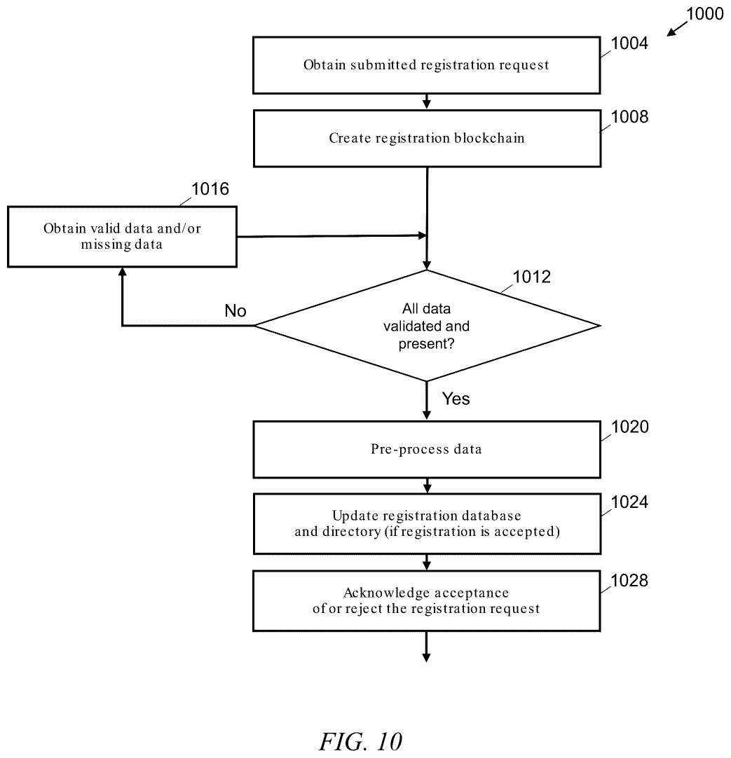

FIG. 5C is a swimlane diagram 550 for an example supply chain scenario, in accordance with an example embodiment. Initially, a distributor 212 submits a registration request with the SCP platform 500 (operation 552). The registration request may be submitted directly via a registration blockchain, indirectly via a website or application, and the like. As described more fully below in conjunction with FIG. 10, the registration request is processed by the registration computerized, code-implemented contract 504 and, in the example of FIG. 5C, the registration is approved and acknowledged (operation 554). Similarly, a manufacturer/vendor 208 submits a registration request with the SCP platform 500 (operation 556). Once again, the registration request may be submitted via a registration blockchain, via a website or application, and the like. In the example of FIG. the registration is approved and acknowledged by the registration computerized, code-implemented contract 504 via the registration blockchain (operation 558).

The distributor 212 submits a request to originate an SPA with an identification of the desired manufacturer/vendor 208 (operation 560). The desired manufacturer/vendor 208 may be identified by accessing a global or other directory provided by the SCP platform 500. The SCP platform 500 responds by creating an SPA blockchain corresponding to the requested SPA (operation 562). In one example embodiment, the blockchain includes details of the requestor's offer, and is accessible by both the distributor 212 and the manufacturer/vendor 208 for processing of the SPA origination request. Moreover, the manufacturer/vendor 208 and the distributor 212 are alerted to the origination of the candidate SPA via the SPA blockchain (operation 564). The manufacturer/vendor 208 may then respond by accepting the offer, providing a counter-offer, or rejecting the offer. In the example of FIG. 5C, the manufacturer/vendor 208 responded with a counter-offer (operation 566). The distributor 212 then reviews and accepts the counter-offer, as in the example of FIG. 5C (operation 568), or provides an amended offer. It is noted that the number of iterative offers and counter-offers varies based on the purviews of the manufacturers/vendors 208 and the distributors 212. Once the negotiation is complete and the terms of the SPA are agreed to, the SCP platform 500 assigns an SPA reference number to the SPA and the SPA blockchain, and the distributor 212 and the manufacturer/vendor 208 are alerted to the establishment of the SPA (operations 570 and 572).

After some period of time, the distributor 212 submits its sales report blockchain transaction in the form of distributor ledger data via the appropriate blockchain (operation 574). (The distributor ledger data may be added to the blockchain corresponding to the SPA covering the items of the sales report (the SPA blockchain), to a blockchain dedicated to the distributor 212, to a blockchain dedicated to the corresponding manufacturer/vendor 208, to a blockchain dedicated to the distributor(s) 212 and the manufacturers/vendors 208 participating in the corresponding SPA(s), and the like.) The distributor 212 may then submit a rebate claim detailing the calculations of the rebate due, or may submit a request for the SCP platform 500 to calculate the rebate, if any, that is due to the distributor 212. In one example embodiment, the SCP platform 500 automatically calculates the rebate, if any, that is due to the distributor 212; that is, the distributor 212 does not need to submit a rebate claim. In the example of FIG. 5C, the rebate settlement computerized, code-implemented contract 516 automatically determines the rebate and issues a rebate report via a rebate blockchain (operations 576, 578). (It is noted that the end-customers 216 and the contractors 220 do not directly participate in the example supply chain scenario depicted in FIG. 5C.)

Purchase/Sales Order Contract

In one example embodiment, a purchase/sales order computerized, code-implemented contract 512 enables the distributor 212 to submit information regarding a purchase order and/or a sales order for one or more items via the SCP platform 500. (As used herein, a purchase order refers to an order to a manufacturer/vendor 208 or similar entity from a distributor 212 and a sales order refers to an order from an end-customer 216, contractor 220, or similar entity to a distributor 212.) Following the submission of the purchase order, the recipient of the purchase order, such as the manufacturer/vendor 208, will issue an invoice to the purchaser and will transfer the item(s) to the purchaser, such as the distributor 212.

In one example embodiment, the purchase/sales order computerized, code-implemented contract 512 enables the distributor 212 to submit purchase order information (such as purchase orders for items from the manufacturer/vendor 208) and sales order information (such as a transaction history of sales with the end-customers 216). The purchase order information and sales order information may be submitted periodically, after execution of a purchase order or sales order, and the like.

In one example embodiment, a purchase order, a sales order, a bill of material, and the like that includes items purchased from a plurality of manufacturers/vendors 208, items sold to end-customers 216, or any combination of the foregoing are submitted to the purchase/sales order computerized, code-implemented contract 512 and the purchase / sales order computerized, code-implemented contract 512 parses the submitted information for entry into the appropriate ledger blocks of the appropriate blockchain(s) as part of a pre-processing operation. As described above, the distributor ledger data may be added to the blockchain corresponding to the SPA covering the items of the sales report (the SPA blockchain), to a blockchain dedicated to the distributor 212, to a blockchain of the corresponding manufacturer/vendor 208, to a blockchain dedicated to the distributor(s) 212 and the manufacturers/vendors 208 participating in the corresponding SPA(s), and the like. In any case, distributor ledger data corresponding to different manufacturers/vendors 208 are segregated by manufacturer/vendor and stored in separate blocks, and potentially separate chains of blocks, from distributor ledger data corresponding to other manufacturers/vendors 208. Importantly, it is noted that manufacturers/vendors 208 and other supply chain participants typically refrain from operating on shared platforms due to security, privacy, antitrust issues, and the like. The exclusion of shared platforms for supply chain processing leads to inefficient use of computing resources and increased processing time to, for example, process bills of material that list items of different manufacturers/vendors 208. For example, multiple platforms may need to be accessed to process the cited bills of material. The architecture described above enables the security, privacy, and antitrust issues noted above to be addressed, enables the support of different manufacturers/vendors 208 and other supply chain participants on an integrated platform, and reduces the computer resources and processing time for managing supply chains and, for example, the rebate process. To access a desired block, well known hashing techniques, such as a use of a random number generator, can be used in the purchase/sales order computerized, code-implemented contract 512 for use as an index into a table based on a given key, thus ensuring efficient random access to locate the desired block in the corresponding chain of blocks in a constant amount of time.

Rebates Settlement Contract

Subsequent to the purchase of items, the distributor 212 may submit its rebate claim(s) via a rebates settlement computerized, code-implemented contract 516, including the sales history for each of the relevant manufacturer's SKUs and indication of the on-hand inventory. This may be performed on a periodic basis (such as daily, weekly, monthly, and the like), when the corresponding items are sold, shipped or delivered, and the like. In one example embodiment, the rebate is calculated automatically by the rebates settlement computerized, code-implemented contract 516 without submission of a rebate claim.

The on-hand inventory, whether received from the distributor 212 or determined by an analysis of purchase orders and sales orders, is used, for example, by the inventory allocation and cost system of the rebates settlement computerized, code-implemented contract 516 to allocate inventory obtained by the distributor 212, assign the correct costing lot (bin) to items sold from the inventory, and calculate the rebate. In some cases, the distributor 212 also provides its on-hand inventory instead of, or in conjunction with, a complete sales history. The rebates settlement computerized, code-implemented contract 516 then accesses data for the manufacturer/vendor 208 and data provided by the distributor 212, and performs any one, some or all of the following actions in the order indicated or an alternative order:
determining whether the agreement was valid on the order date;
determining whether the end-customer 216 and/or the branch of the distributor 212 is listed on the SPA for the given order date;
determining whether the SKU is covered by the SPA on the order date (if a product group is provided, the corresponding SKU or SKUs may be obtained and the validation performed);
determining the agreed-upon multiplier or net price for the SKU;
determining the list price as of the order date;
determining the into-stock cost and/or the true acquisition cost for the distributor 212 as of the order date; and
calculating the rebate.

It is noted that the manufacturer/vendor part number vs. distributor part number cross-reference database may be used to determine and/or confirm the part number(s) for a particular item.

FIG. 6A is a flowchart for an example method 650 for originating a special price agreement, in accordance with an example embodiment. In one example embodiment, a request to originate the special price agreement is obtained from a special price agreement requestor (operation 654), and the special price agreement blockchain corresponding to the special price agreement is established by a special price agreement origination computerized, code-implemented contract 508 (operation 658). A determination is made of whether the special price agreement requestor has omitted information needed by the special price agreement origination computerized, code-implemented contract 508 (decision block 662). If all of the required data is verified and present (YES branch of decision block 662), a block is added to the special price agreement blockchain, the block comprising requestor information (operation 666). If all of the required data is not verified and present (NO branch of decision block 662), the invalid and/or missing information is requested and obtained (operation 686) and the method 650 proceeds with operation 662.

In one example embodiment, an SPA acceptance or counter-offer is obtained from the requestee and a corresponding block is added to the SPA blockchain (operation 670). An acceptance of the original SPA or the counter-offer is obtained from the requestor (operation 674) and an SPA terms block is added to the SPA blockchain (operation 678).

Blockchain Ledger Definition and Methods

FIG. 6B is a flowchart for an example method 600 for populating the manufacturer ledger blocks of a blockchain, in accordance with an example embodiment. The method 600 is performed periodically to maintain the freshness of the manufacturer ledger blocks of the blockchain. The manufacturer ledger blocks are defined, ingested, and maintained using the purchase/sales order computerized, code-implemented contract 512 and the rebates settlement computerized, code-implemented contract 516 of the blockchain supply chain processing platform 500. It is noted that data exists in many different forms across manufacturers/vendors 208, distributors 212, and the like; manufacturers/vendors 208 may store data required by the ledger in many different tables on an ERP system or other system. As described above, the basic data requirements of the blockchain supply chain processing platform 500 for the manufacturers/vendors 208 include any one, some or all of the following:

SKU Master with product grouping (hierarchy), such as the SKU data for each product grouping, including SKU attribute change log (captures SKU additions/deletions and describes the SKU hierarchy for a given point-in-time) and a historical list price change log (to calculate point-in-time list price; all the change log data & product hierarchy data is housed in different tables/schemas that are joined/connected);
master version of the SPA, including customer accounts (SPA attribute change log to maintain variations in the SPA);
distributor sales orders (describes products, quantities, and price paid);
pre-processing logic (general pre-processing rules and/or logic per distributor 212);
manufacturer's/vendor's part number vs. distributor part number cross-reference database; and
distributor number vs. manufacturer's distributor account number cross-reference database, including a distributor location number vs. manufacturer's distributor location account number cross-reference database.

In one example embodiment, a manufacturer/vendor transaction ledger blockchain that supports multiple entities of the supply chain processing system 500 is instantiated. The entities may be departments, subsidiaries, and the like of a single commercial enterprise, or may be commercial entities, including cooperating commercial entities, competing commercial entities, and the like. Initially, the manufacturer/vendor ERP system is accessed to retrieve manufacturer/vendor data designated for blockchain entry (operation 604). The manufacturer/vendor data designated for blockchain entry is validated (operation 608). A new blockchain is instantiated or an existing blockchain is identified for entry of the validated data (operation 610) and a check is performed to determine if all data is verified and present (decision block 612). If all data is not verified and present (NO branch of decision block 612), the invalid and/or missing data is requested and obtained (operation 614) and logical flow passes back to operation 604; otherwise (YES branch of the decision block 612), the data is pre-processed to, for example, format the data for entry in the ledger of the blockchain and add a timestamp indicating, for example, the time of receiving a purchase order (operation 616) and the validated manufacturer/vendor data is populated into the corresponding blockchain (operation 620). The method 600 then waits for availability of additional manufacturer/vendor data designated for blockchain entry. It is noted that the blocks of the blockchain inherently enable a time-series record of sales prices and the like. In one example embodiment, during operation 616, an index entry for the block is generated (as described above). The indices may be keyed to the manufacturers/vendors 208, the distributors 212, the SKUs, and the like.

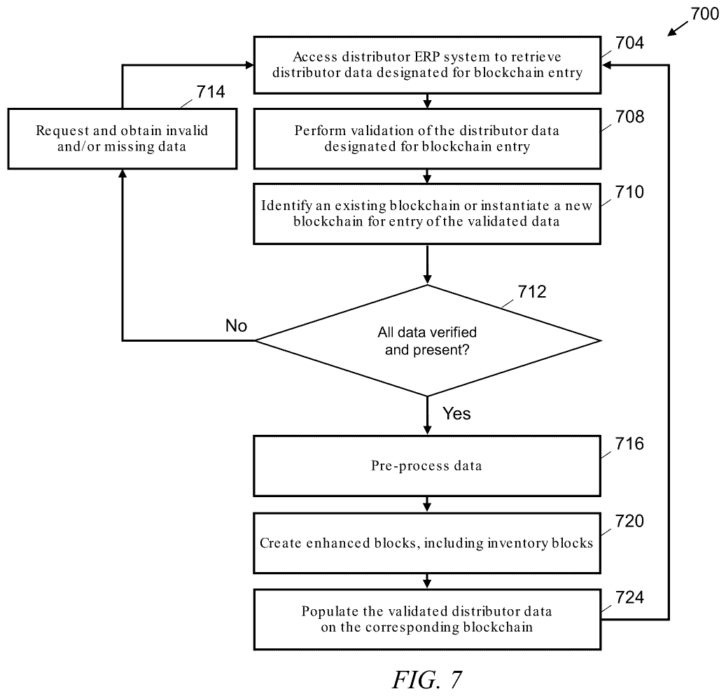

FIG. 7 is a flowchart for an example method 700 for populating the distributor ledger blocks of a blockchain, in accordance with an example embodiment. The distributor ledger blocks are defined, ingested, and maintained using the purchase/sales order computerized, code-implemented contract 512 and the rebates settlement computerized, code-implemented contract 516 of the blockchain supply chain processing platform 500. The distributor 212 submits its sales history for the manufacturer's SKUs and its on-hand inventory on a periodic basis (such as daily, weekly, monthly, and the like) or based on an event (such as the when the corresponding items are sold, shipped or delivered, and the like) for the inventory allocation and cost system to use to allocate inventory. (As described above, in one example embodiment, the supply chain processing platform 500 automatically calculates the rebate and the distributor 212 is not required to submit a rebate claim. The supply chain processing platform 500 may also determine the on-hand inventory by analyzing the relevant purchase orders and sales orders.) In one example embodiment, the distributor ledger blocks are populated periodically in instances where items are sold from the inventory of the distributor 212 and populated based on an event if the sale is related to a purchase order. In one example embodiment, the sales history is submitted for all the manufacturer's SKUs carried by the distributor 212. As described above, the basic data requirements of the blockchain supply chain processing platform 500 for the distributor 212 include:
rebate claims with end-customer(s) 216, including distributor number, distributor branch number, manufacturer's/vendor's 208 catalog number, UPC, order number, order line number, order date, invoice number, invoice line number, invoice date, quantity, standard/into-stock cost, rebate cost, SPA reference number, and rebate claim amount;
complete sales history for all manufacturer SKUs (to support the inventory allocation and cost system); and
on-hand inventory balance at different distributor locations.

In one example embodiment, the distributor 212 or a similar entity will report item returns related to previously reported sales such that the inventory allocation and cost system maintains an accurate view of the existing inventory. It is noted that some of the required data is provided by the distributor 212 while other data is provided by the rebates settlement computerized, code-implemented contract 516. For example, the SPA reference number is provided by the distributor 212 while the rebate is determined by the rebates settlement computerized, code-implemented contract 516. In addition, the data of the complete sales history may vary. For example, information on the end-customer 216 will be included if the terms of the SPA are based on the end-customer 216, but may be excluded if the SPA does not consider the identity of the end-customer 216.

In one example embodiment, the distributor 212 provides: (1) the reference number of the SPA that offers the best terms to the distributor 212; (2) no SPA reference number (in which case the blockchain supply chain processing platform 500 determines the reference number of the SPA that offers the best terms for the distributor 212); or (3) the reference number(s) of the SPA(s) that are available to the distributor 212 (in which case the blockchain supply chain processing platform 500 determines the reference number of the SPA of those available that offers the best terms to the distributor 212). The best SPA may be determined by determining the rebate amount for each eligible SPA and selecting the SPA with the highest rebate amount. In one example embodiment, a distributor profile in the blockchain supply chain processing platform 500 is configured during the registration process to indicate whether the blockchain supply chain processing platform 500 is authorized to determine the reference number of the SPA that offers the best terms (such as lowest price) to the distributor 212. In one example embodiment, the authorization to determine the reference number of the SPA that offers the best terms to the distributor 212 is based on specificity rules that correspond to the SPA. For example, a specificity rule may indicate that the distributor 212 is entitled to the lowest price available among all the eligible SPAs.

With continued reference to FIG. 7, in one example embodiment, a distributor transaction ledger blockchain that supports multiple entities of the supply chain processing system 500 is instantiated. The entities may be departments, subsidiaries, and the like of a single commercial enterprise, or may be individual commercial enterprises, including cooperating commercial enterprises, competing commercial enterprises, and the like. Initially, the distributor ERP system is accessed to retrieve distributor data designated for blockchain entry (operation 704). The distributor data designated for blockchain entry is validated (operation 708). For example, determining that an SPA reference number is valid and that the quantity of the sold items is listed. A new blockchain is instantiated or an existing blockchain is identified for entry of the validated data (operation 710) and a check is performed to determine if all data is verified and present (decision block 712). If all data is not verified and present (NO branch of decision block 712), the invalid and/or missing data is requested and obtained (operation 714) and logical flow passes back to operation 704; otherwise (YES branch of the decision block 712), the data is pre-processed to, for example, format the data for entry in the ledger of the blockchain and add a timestamp indicating, for example, the time of the submission of a purchase order (operation 716). In one example embodiment, distributor ledger data corresponding to different manufacturers/vendors 208 are segregated by manufacturer/vendor as part of the pre-process operation and stored in separate blocks of a chain of blocks, and potentially as parts of separate chains of blocks, from distributor ledger data corresponding to other manufacturers/vendors 208. In one example embodiment, during operation 716, an index entry for the generated block(s) is generated (as described above). The indices may be keyed to the manufacturers/vendors 208, the distributors 212, the SKUs, and the like.

In one example embodiment, an inventory blockchain(s) is maintained to provide a snapshot of the current inventory level of the inventory of the distributor 212 (operation 720). As purchase orders are pre-processed, the snapshot is updated to depict the existing inventory with the addition of the purchased items, identified by purchase date, quantity and into-stock cost(s). As sales orders are pre-processed, the snapshot is updated to depict the existing inventory with the deletion of the sold items, identified by sales date and quantity (the SPA price, that is, the end-customer price may also be included). The rebates settlement computerized, code-implemented contract 516 uses a FIFO methodology to adjust the quantity of each bin, where each bin corresponds to a particular into-stock cost, such that the rebates settlement computerized, code-implemented contract 516 can determine the true acquisition cost as items are sold. The snapshots of the current inventory level of the inventory may be stored in inventory blocks. The inventory blocks are indexed by a combination of manufacturer/vendor 208, distributor 212, and item identifier (such as SKU) for easy access to and determination of the into-stock cost and the true acquisition cost. The inventory blocks may be maintained in an inventory blockchain, the distributor blockchain, the blockchain of the corresponding SPA, and the like. The validated distributor data is then populated into a block of the corresponding blockchain (operation 724) and the method 700 then waits for availability of additional distributor data designated for blockchain entry. As described above, the distributor ledger data may be added to the blockchain corresponding to the SPA covering the items of the sales report (the SPA blockchain), to a blockchain dedicated to the distributor 212, to a blockchain of the corresponding manufacturer/vendor 208, to a blockchain dedicated to the distributor(s) 212 and the manufacturers/vendors 208 participating in the corresponding SPA(s), and the like.

In one example embodiment, the methods 600, 700 are used to import legacy special price agreements into the supply chain processing system 500. Initially, a file-based special pricing agreement in a non-blockchain format is parsed (operation 604, 704), data of the non-blockchain format is filtered in accordance with terms of an inventory allocation and cost system of the supply chain processing system 500 (operation 616, 716), the filtered data is processed (operation 616, 716), and the processed data is stored in one or more blocks of the special price agreement blockchain or another designated blockchain (operation 620, 724).

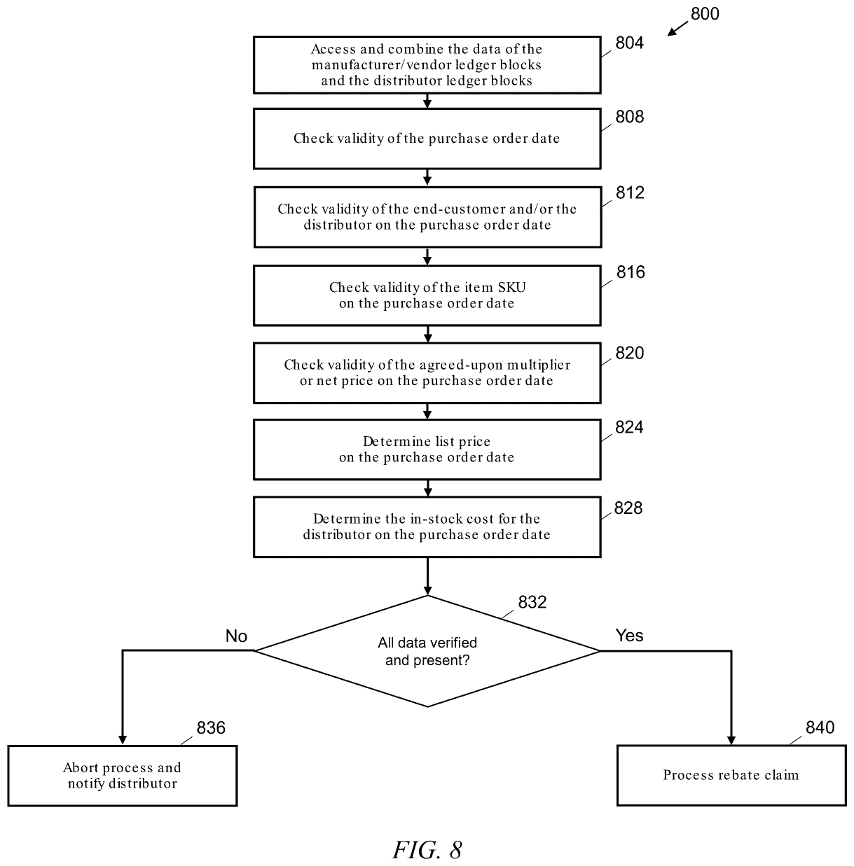

FIG. 8 is a flowchart for an example method 800 for pre-processing the blockchain data of the manufacturer/vendor 208 and the blockchain data of the distributor 212, in accordance with an example embodiment. As described above, once the data required to process a rebate request is available in the blockchain (as generated by the example methods 600, 700 of FIGS. 6 and 7, respectively), the rebates settlement computerized, code-implemented contract 516 is triggered to access the SPA data and process the data from the ledger blocks of the manufacturer/vendor 208 and the ledger blocks of the distributor 212 (operation 804). As described above, the on-hand inventory data may be obtained from the most recent inventory block that corresponds to the items under consideration as identified, for example, by their SKU. The SPA block(s) may be located and accessed by using an index of SPAs (note that all of the relevant terms of the most recent version of the SPA may be stored in a single block; alternatively, the rebates settlement computerized, code-implemented contract 516 will determine the relevant terms of the most recent version of the SPA by accessing the terms of the original SPA block and compiling the present terms based on blocks corresponding to subsequent amendments to the SPA). Similarly, the blocks of the manufacturers/vendors 208 and the distributors 216 may be located and accessed by using an index corresponding to the manufacturers/vendors 208, the distributors 216, SKU and the like. The rebates settlement computerized, code-implemented contract 516 then performs any one, some or all of the following actions in the order indicated or an alternative order by, for example, by examining the original SPA and subsequent changes to the SPA:
determining whether the agreement is valid on the order date (operation 808);
determining whether the end-customer 216 and/or the branch of the distributor 212 is listed on the SPA on the order date (operation 812);
determining whether the SKU is covered by the SPA on the order date (if a product group is provided, the corresponding SKU or SKUs may be obtained and the validation performed) (operation 816);
determining the validity of the agreed-upon multiplier or net price for the SKU on the purchase order date (operation 820);
determining the list price as of the purchase order date (operation 824); and
determining the into-stock and/or true acquisition cost for the distributor 212 on the purchase order date (operation 828).

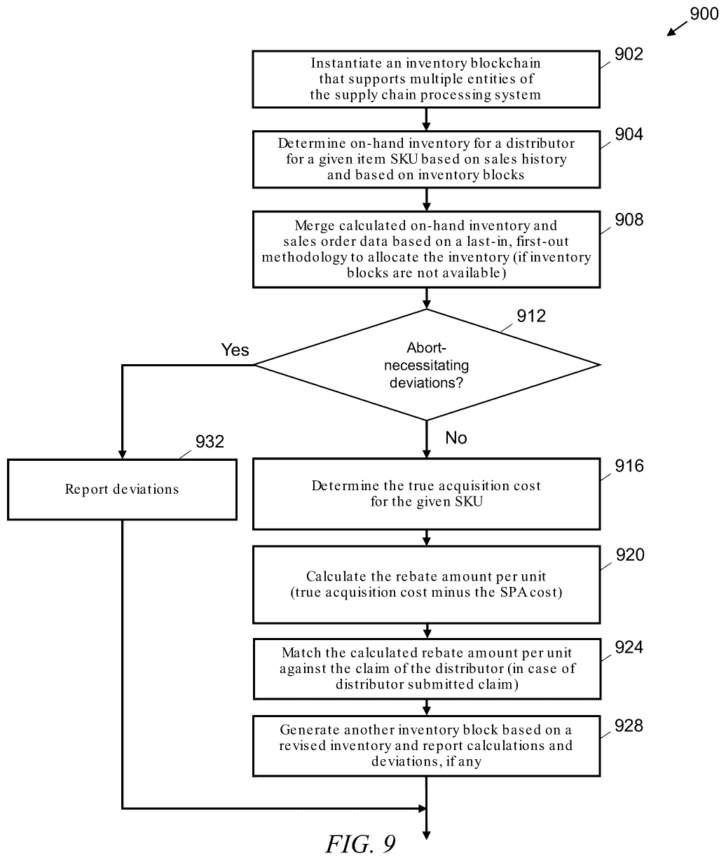

A check is performed to determine if all data is present and verified (decision block 832). If all data is not present and verified (NO branch of decision block 832), the process is aborted and the distributor 212 is notified (operation 836); otherwise (YES branch of decision block 832), the rebate claim is processed (operation 840), as described more fully below by way of example in conjunction with FIG. 9.

FIG. 9 is a flowchart for an example method 900 for processing a rebate claim(s) using the inventory allocation and cost system of the blockchain embodiment of the supply chain processing platform 500, in accordance with an example embodiment. In one example embodiment, an inventory blockchain that supports multiple entities of the supply chain processing platform 500 is instantiated (operation 902). The inventory allocation and cost system determines the on-hand inventory of a distributor 212 for a given SKU, including distributor branch and location. This may be based on a description of the on-hand inventory provided by the distributor 212, by an analysis of the sales history, the purchase history, or both provided by the distributor 212, and the like (operation 904). This may also be accomplished by revising the latest inventory details provided by the distributor 212 in light of reported (subsequent) sales (reductions in inventory) and purchases (increases in inventory). In one example embodiment, the on-hand inventory of a distributor 212 is calculated by analyzing the purchase history and the sales history provided by the distributor 212 for each relevant SKU (eliminating the need for the distributor 212 to provide a description of the current inventory). In one example embodiment, the on-hand inventory is determined by accessing the most recent inventory block corresponding to the given item.

The calculated data is merged with the data of the manufacturer/vendor 208 based on a first-in (oldest-in), first-out methodology to allocate the inventory (operation 908). A check is then performed to determine if deviations are found that necessitate aborting the method 900 (operation 912). For example, a check is performed to determine whether the manufacturer/vendor 208 reports a different purchase quantity than reported by the distributor 212. If deviations necessitating aborting the method 900 are found (YES branch of decision block 912), the deviations are reported (operation 932) and the method 900 ends. If deviations necessitating aborting the method are not found (NO branch of decision block 912), the true acquisition cost is determined for the inventory of the given SKU that was sold (for example, the relevant price multiplier may be applied to the list price to arrive at the true acquisition cost for the distributor 212 for each bin that was utilized in the sale of the item) (operation 916). (In one example embodiment, the true acquisition cost is maintained as a component of the corresponding inventory block and may simply be determined by accessing that block.) The SPA or rebated cost is determined, the rebate amount per unit (into-stock cost minus the SPA or rebated cost or the true acquisition cost minus the SPA or rebated cost) is calculated for each unit sold, and a total rebate based on the rebate amount and a sales quantity corresponding to the given item identifier is determined (operation 920). If a claim has been submitted by the distributor 212, the rebate amount per unit is matched against the claim of the distributor 212 (operation 924). For example, the rebate amount for each of ten units would be determined by identifying the ten units having the longest amount of time residing in the inventory, determining the into-stock cost and the true acquisition cost that correspond to each of the ten units, locating the SPA or rebated cost of each of the ten units using the eligible SPA and determining the rebate amount for each of the ten units, and then summing the ten determined rebate amounts. The calculation steps are then reported and any deviations are reported via a block of the blockchain (operation 928). For example, a rebate blockchain may be updated based on the determined total rebate. In one example embodiment, a new inventory block is generated with a revised description of the current inventory as part of operation 928. It is noted that the settlement of funds corresponding to the above calculated rebate amount is performed in a manner known to the skilled artisan. For example, if the calculated rebate amount is US$12,000, the transfer of the US$12,000 from the manufacturer/vendor 208 to the distributor 212 is performed using known techniques.

FIG. 10 is a flowchart for an example method 1000 for registering a participant with the blockchain embodiment of the supply chain processing platform 500, in accordance with an example embodiment. In one example embodiment, a candidate for registration submits a request to register via, for example, a website, a client application, and the like (operation 1004). A registration blockchain is created based on the registration application submitted by the candidate participant (operation 1008). A check is performed to determine if all necessary registration data is verified and present (decision block 1012). If all the registration data is not verified and present (NO branch of decision block 1012), the invalid and/or missing data is requested and obtained (operation 1016) and the check of block 1012 is repeated until a YES is obtained. If and when all the registration data is verified and present (YES branch of the decision block 1012), the data is pre-processed to, for example, format the data for entry in the registration database and the directory of the supply chain processing platform 500 (operation 1020), the registration database and the directory are updated to reflect the registration of the new participant (operation 1024) and the acceptance of the registration request is acknowledged to the requester via the registration blockchain (operation 1028). For example, a block may be added to the registration blockchain detailing the valid dates of the registration, the participant's registration number, a temporary user password, and the like.

Reporting Layer

In one example embodiment, the smart contracts of the supply chain processing platform 500 provide reporting functionality. For example, the rebates settlement computerized, code-implemented contract 516 issues a report detailing the calculations of the rebate verification process, issues an indication of whether a rebate claim submitted by a distributor 212 is approved, and the like. The report is automatically generated, and may also be accessed upon request to the rebates settlement computerized, code-implemented contract 516. The rebates settlement computerized, code-implemented contract 516 also provides access to the distributor ledger data and the manufacturer/vendor ledger data of the blockchain. For example, the distributor 212 may submit a request to the rebates settlement computerized, code-implemented contract 516 to view the ledger data of a particular blockchain. In one example embodiment, the data accessible by an entity, such as the distributor 212, may be limited by the supply chain processing platform 500. For example, the distributor 212 may be blocked from viewing the ledger data (or a portion of the ledger data) for the manufacturer/vendor 208, manufacturers/vendors 208 may be blocked from accessing the data (such as ledger blocks) of competing manufacturers/vendors 208, and the like. Access to data may be authorized by the supply chain processing platform 500 based on access terms defined in a corresponding SPA(s).

In one example embodiment, the SPA origination computerized, code-implemented contract 508 may be queried for the terms of an SPA and the registration computerized, code-implemented contract 504 may be queried for a directory of registered participants of the supply chain processing platform 500.

Legacy Data Importation

In one example embodiment, the SPA origination computerized, code- implemented contract 508 supports the importation of legacy SPAs. Legacy SPAs may be submitted, for example, via an import file. In one example embodiment, custom software is crafted to parse the legacy SPAs in their native format and the custom software formats the parsed data for submission to the SPA origination computerized, code-implemented contract 508 which then generates a blockchain corresponding to the SPA.

In one example embodiment, the information needed by the inventory allocation and cost system, as described more fully above, is imported into the supply chain processing platform 500 as part of the legacy data importation process. For example, the SPA origination contract computerized, code-implemented 508 or the rebates settlement computerized, code-implemented contract 516 may be tasked with obtaining the current state of the inventory (including, for example, SKUs, corresponding quantities, and corresponding into-stock costs). This information may be obtained directly from the distributor 212, or generated by the SPA origination computerized, code-implemented contract 508 or the rebates settlement computerized, code-implemented contract 516 based on information provided by the distributor 212 and/or the manufacturer/vendor 208.

Given the discussion thus far, it will be appreciated that, the distributors 212 and the manufacturers/vendors 208 conventionally have competing interests and utilize different enterprise resource planning (ERP) systems, disparate data structures (including different sets of SKUs, part numbers and the like), different communication methods, and the like, creating a complex heterogenous environment that has traditionally proven difficult to manage due, in part, to a lack of trust in shared platforms (platforms shared by different enterprises and, potentially, shared by competitors) and disparate data structures. In general, conventional shared platforms lack the technical solution to give entities rapid access to management data that is secure and trusted by the participants in the supply chain for management purposes. The exclusion of shared platforms for supply chain processing leads to inefficient use of computing resources and increased processing time to, for example, process bills of material. For example, multiple platforms may need to be accessed to process a bill of material that includes items from different manufacturers; multiple workflows need to be supported, requiring users to learn the protocols of a variety of workflows. The architecture described above addresses the security, privacy, and antitrust issues noted above, enables the support of a plurality of manufacturers/vendors 208 and other supply chain participants on an integrated platform, and reduces the computer resources and processing time for managing supply chains and, for example, the rebate process.

The supply chain processing platform 500 utilizes a blockchain architecture that is secure and trusted by the participants of the supply chain and, for example, automatically generates trusted accurate rebate calculations using a blockchain-compatible inventory allocation and cost system. It provides a single set of workflows for use by a variety of entities, including entities in competitive relationships. To enable use of a blockchain architecture, in one example embodiment, the purchase/sales order computerized, code-implemented contract 512 parses submitted information, such as a purchase order, a sales order, a bill of material, and the like (that includes items purchased from a plurality of manufacturers/vendors 208) and segregates the information by manufacturer, as part of a pre-processing operation, to prepare the information for entry into the appropriate ledger blocks of the appropriate blockchain(s) thereby providing the security and privacy demanded by the participants of the supply chain management system and enabling the determination of the true acquisition cost needed for rebate processing. As described above, the distributor ledger data may be added to the blockchain corresponding to the SPA covering the items of the sales report (the SPA blockchain), to a blockchain dedicated to the distributor 212, to a blockchain of the corresponding manufacturer/vendor 208, and the like. In any case, distributor ledger data corresponding to different manufacturers/vendors 208 are segregated by manufacturer/vendor and stored in separate blocks, and potentially separate chains of blocks, from distributor ledger data corresponding to other manufacturers/vendors 208.

The transition to a blockchain architecture also introduces other technical issues in comparison to a conventional database architecture. While the data in a chain of blocks is immutable and thereby provides a certain level of trust, the immutability leads to a growing number of blocks in the chain of blocks, and thus locating the information required to, for example, process a rebate claim can prove challenging. Thus, it will be appreciated that technical problems arise when seeking to use blockchain. In one example embodiment, the introduction of an inventory blockchain overcomes the technical problem posed by the immutability of the data, advantageously providing a snapshot of the current inventory level of the distributor 212, enabling easy access to the required information. As purchase orders are pre-processed, the snapshot is updated to depict the existing inventory with the addition of the purchased items, identified by purchase date, quantity and into-stock cost(s). As sales orders are pre-processed, the snapshot is updated to depict the existing inventory with the deletion of the sold items, identified by sales date and quantity (the SPA price, that is, the end-customer 216 price may also be included). The rebates settlement computerized, code-implemented contract 516 uses a FIFO methodology to adjust the quantity of each bin, where each bin corresponds to a particular into-stock cost, such that the rebates settlement computerized, code-implemented contract 516 can determine the true acquisition cost as items are sold. The snapshots of the current inventory level of the inventory are stored in inventory blocks. The inventory blocks are indexed by a combination of manufacturer/vendor 208, distributor 212, and item identifier (such as SKU) for easy access to and determination of the into-stock cost and the true acquisition cost. The inventory blocks may be maintained in an inventory blockchain, in the distributor blockchain, in the blockchain of the corresponding SPA, and the like.

To provide support for legacy supply chain information (such as inventory levels and legacy SPAs), in one example embodiment, the information needed by the inventory allocation and cost system, as described more fully above, is imported into the supply chain processing platform 500 as part of a legacy data importation process compatible with a blockchain architecture. For example, the SPA origination contract computerized, code-implemented 508 or the rebates settlement computerized, code-implemented contract 516 may be tasked with obtaining the current state of the inventory (including, for example, SKUs, corresponding quantities, and corresponding into-stock costs). This information may be obtained directly from the distributor 212, or generated by the SPA origination computerized, code-implemented contract 508 or the rebates settlement computerized, code-implemented contract 516 based on purchase and sales information provided by the distributor 212 and/or the manufacturer/vendor 208.

In general terms, an exemplary method for processing rebates on a supply chain processing system 500 based on a blockchain architecture, according to an aspect of the invention, includes the operations of instantiating an inventory blockchain that supports multiple entities of the supply chain processing system 500 (operation 902); determining, in response to a change in a ledger block of a transaction ledger blockchain, an on-hand inventory for a given item identifier based on a reported sales history and an inventory block comprising inventory metadata that describes a temporal snapshot of the on-hand inventory (operation 904); determining a unit and cost allocation of the on-hand inventory using the inventory metadata (operation 908); determining a true acquisition cost for the given item identifier based on the inventory metadata of the inventory block and the determined allocation (operation 916); determining a special price agreement cost based on a special price agreement block, the special price agreement block comprising terms of a special price agreement (operation 920); calculating a rebate amount corresponding to the given item identifier based on the special price agreement cost and the true acquisition cost (operation 920); determining a total rebate based on the rebate amount and a sales quantity corresponding to the given item identifier (operation 920); generating another inventory block based on a revised inventory (operation 928); and updating a rebate blockchain based on the determined total rebate (operation 928).

In one example embodiment, the determining the allocation of the on-hand inventory further comprises merging the reported sales history with purchase orders of a manufacturer/vendor 208 based on a first-in, first-out methodology (operation 908). In one example embodiment, the total rebate and a submitted rebate claim are compared (operation 924); and rebate calculation steps between the total rebate and the submitted rebate claim are reported via a block of the rebate blockchain (operation 928). In one example embodiment, one or more of the determining and calculating operations are repeated, one or more deviations that necessitate aborting the processing of rebates are detected (operation 912), and the deviations are reported via a block of the rebate blockchain (operation 932).

In one example embodiment, whether the special price agreement is valid on a given order date is determined by examining an original special price agreement and any subsequent changes to the special price agreement as defined in the special price agreement blockchain (operation 808), whether at least one of an end-customer 216 and a branch of a distributor 212 are listed on the special price agreement is determined based on the given order date (operation 812), whether a stock keeping unit is covered by the special price agreement on the given order date is determined (operation 816), a validity of at least one of an agreed-upon multiplier and a net price for the stock keeping unit on the given order date is determined (operation 820), a list price for the stock keeping unit corresponding to the given order date is determined (operation 824), and at least one of an into-stock cost and a true acquisition cost for the distributor 212 on the given order date is determined (operation 828). In one example embodiment, the calculation steps of the rebate process are accessed via the rebate blockchain, a rebate claim report is generated, and the rebate claim report is provided via a rebate processing computerized, code-implemented contract 504.

In one example embodiment, a request to originate the special price agreement is obtained from a special price agreement requestor (operation 654), the special price agreement blockchain corresponding to the special price agreement is established by a special price agreement origination computerized, code-implemented contract 508 (operation 658), whether the special price agreement requestor has omitted information needed by the special price agreement origination computerized, code-implemented contract 508 is determined by the special price agreement origination computerized, code-implemented contract 508 (operation 662), a block is added to the special price agreement blockchain, the block comprising requestor information (operation 666), a special price agreement approval or a counter-offer is obtained from a special price agreement requestee via an approval block of the blockchain (operation 670), and a special price agreement terms block is added to the special price agreement blockchain (operation 678). In one example embodiment, an assigned special price agreement reference number is obtained from the special price agreement requestee, wherein the special price agreement blockchain comprises the assigned special price agreement reference number. In one example embodiment, the requestor information comprises terms of a special price agreement offer.

In one example embodiment, a counter-offer is obtained from the special price agreement requestee (operation 670); and an acceptance of the counter-offer by the special price agreement requester is obtained (operation 674). In one example embodiment, ledger data is accessed via a corresponding blockchain, a ledger report is generated, and the ledger report is provided via the special price agreement origination computerized, code-implemented contract 508. In one example embodiment, access by a specified entity to specified data of at least one of the rebate blockchain and the transaction ledger blockchain is controlled based on one or more access rules. In one example embodiment, at least one access rule is based on one or more of: enabling access by all entities specified on the corresponding special price agreement, enabling access by all entities specified in an access profile, blocking access by all entities absent from a list of enabled entities in the access profile, and blocking access by all entities absent from the corresponding special price agreement. In one example embodiment, the access profile is maintained by the supply chain processing platform 500.

In one example embodiment, a search for blocks in a special price agreement blockchain that comprise original terms of the special price agreement and modified terms of the special price agreement is performed, the original terms and the modified terms corresponding to the searched blocks are obtained, a summary of terms of the special price agreement valid for a specified date is generated, the summary of terms excluding expired terms of the special price agreement, and the summary of terms is provided via the special price agreement origination computerized, code-implemented contract 508 (operation 920). In one example embodiment, a file-based special pricing agreement in a non-blockchain format is parsed (operation 604, 704), data of the non-blockchain format is filtered in accordance with terms of an inventory allocation and cost system of the supply chain processing system 500 (operation 616, 716), the filtered data is processed (operation 616, 716), and the processed data is stored in one or more blocks of the special price agreement blockchain (operation 620, 724). In one example embodiment, inventory and sales data is loaded in one or more additional blocks of at least one of the special price agreement blockchain and the transaction ledger blockchain (operation 620, 724, 928).

In one example embodiment, a registration application to register with the supply chain processing system 500 is obtained from a registration requester (operation 1004), a registration blockchain is created by a registration computerized, code-implemented contract 504 based on the registration application submitted by the registration requester (operation 1008), the registration application is pre-processed to format registration data of the registration application for entry in a registration database and a participant directory of the supply chain processing system 500 (operation 1020), the registration database and the participant directory are updated to reflect a registration of the registration requester (operation 1024), and acceptance of the registration request is acknowledged to the registration requester via the registration blockchain (operation 1028). In one example embodiment, a determination is made if registration data required by the registration computerized, code-implemented contract 504 is verified and present (decision block 1012) and at least one of invalid data and missing data is requested and obtained in response to determining that the registration data is not verified and present (operation 1016). In one example embodiment, the participant directory comprises a proper subset of registered participants.

In one aspect, an exemplary method includes the operations of instantiating one or more transaction ledger blockchains that support multiple entities (operation 610, 710); accessing an enterprise system of one of the multiple entities to retrieve special price agreement participant data designated for blockchain entry (operation 604, 704), validating the accessed data designated for the blockchain entry (operation 608, 708), identifying a transaction ledger blockchain of the one or more transaction ledger blockchains for entry of the validated data (operation 610, 710), pre-processing the validated data, the pre-processing comprising formatting the validated data for entry in a ledger block of the identified transaction ledger blockchain with a timestamp corresponding to the accessed data (operation 616, 716), and populating the pre-processed data into the ledger block of the identified transaction ledger blockchain (operation 620, 724).

In one example embodiment, the special price agreement participant data comprises a sales history for a given SKU and an identification of on-hand inventory corresponding to the given SKU for an inventory allocation and cost system to use to allocate distributor inventory. In one example embodiment, additional ledger blocks are at least one of populated periodically, populated when items are sold from an inventory of a distributor 212, and populated upon an executed sale corresponding to a purchase order. In one example embodiment, the identified transaction ledger blockchain is at least one of a blockchain corresponding to a special price agreement covering the special price agreement participant data, a blockchain dedicated to a manufacturer associated with the special price agreement participant data, a blockchain dedicated to a distributor associated with the special price agreement participant data, a blockchain dedicated to a set of manufacturers, and a blockchain dedicated to a set of distributors. In one example embodiment, the pre-processing further comprises segregating data that references items corresponding to a plurality of the entities in accordance with the corresponding entity and wherein the populating of the pre-processed data into the ledger block populates the segregated data into corresponding segregated blocks, each segregated block corresponding to one of the plurality of entities (operation 616, 716). In one example embodiment, inventory metadata is generated based on at least one of purchase order information and sales order information, the inventory metadata indicating a size of each inventory bin and an into-stock cost for each inventory bin, and an inventory block is created based on the inventory metadata (operation 928).

In one aspect, a non-transitory computer readable medium comprises computer executable instructions which when executed by a computer cause the computer to perform a method for processing rebates on a supply chain processing system based on a blockchain architecture, the method comprising the operations of instantiating an inventory blockchain that supports multiple entities of the supply chain processing system 500 (operation 902); determining, in response to a change in a ledger block of a transaction ledger blockchain, an on-hand inventory for a given item identifier based on a reported sales history and an inventory block comprising inventory metadata that describes a temporal snapshot of the on-hand inventory (operation 904); determining a unit and cost allocation of the on-hand inventory using the inventory metadata (operation 908); determining a true acquisition cost for the given item identifier based on the inventory metadata of the inventory block and the determined allocation (operation 916); determining a special price agreement cost based on a special price agreement block, the special price agreement block comprising terms of a special price agreement (operation 920); calculating a rebate amount corresponding to the given item identifier based on the special price agreement cost and the true acquisition cost (operation 920); determining a total rebate based on the rebate amount and a sales quantity corresponding to the given item identifier (operation 920); generating another inventory block based on a revised inventory (operation 928); and updating a rebate blockchain based on the determined total rebate (operation 928).

In one aspect, a non-transitory computer readable medium comprises computer executable instructions which when executed by a computer cause the computer to perform a method of instantiating one or more transaction ledger blockchains that support multiple entities (operation 610, 710), accessing an enterprise system of one of the multiple entities to retrieve special price agreement participant data designated for blockchain entry (operation 604, 704), validating the accessed data designated for the blockchain entry (operation 608, 708), identifying a transaction ledger blockchain of the one or more transaction ledger blockchains for entry of the validated data (operation 610, 710), pre-processing the validated data, the pre-processing comprising formatting the validated data for entry in a ledger block of the identified transaction ledger blockchain with a timestamp corresponding to the accessed data (operation 616, 716), and populating the pre-processed data into the ledger block of the identified transaction ledger blockchain (operation 620, 724).

In one aspect, an apparatus comprises a memory and at least one processor, coupled to the memory, and operative to perform a method for processing rebates on a supply chain processing system based on a blockchain architecture, the method comprising operations of instantiating an inventory blockchain that supports multiple entities of the supply chain processing system 500 (operation 902); determining, in response to a change in a ledger block of a transaction ledger blockchain, an on-hand inventory for a given item identifier based on a reported sales history and an inventory block comprising inventory metadata that describes a temporal snapshot of the on-hand inventory (operation 904); determining a unit and cost allocation of the on-hand inventory using the inventory metadata (operation 908); determining a true acquisition cost for the given item identifier based on the inventory metadata of the inventory block and the determined allocation (operation 916); determining a special price agreement cost based on a special price agreement block, the special price agreement block comprising terms of a special price agreement (operation 920); calculating a rebate amount corresponding to the given item identifier based on the special price agreement cost and the true acquisition cost (operation 920); determining a total rebate based on the rebate amount and a sales quantity corresponding to the given item identifier (operation 920); generating another inventory block based on a revised inventory (operation 928); and updating a rebate blockchain based on the determined total rebate (operation 928).

In one aspect, an apparatus comprises a memory and at least one processor, coupled to the memory, and operative to perform operations comprising instantiating one or more transaction ledger blockchains that support multiple entities (operation 610, 710), accessing an enterprise system of one of the multiple entities to retrieve special price agreement participant data designated for blockchain entry (operation 604, 704), validating the accessed data designated for the blockchain entry (operation 608, 708), identifying a transaction ledger blockchain of the one or more transaction ledger blockchains for entry of the validated data (operation 610, 710), pre-processing the validated data, the pre-processing comprising formatting the validated data for entry in a ledger block of the identified transaction ledger blockchain with a timestamp corresponding to the accessed data (operation 616, 716), and populating the pre-processed data into the ledger block of the identified transaction ledger blockchain (operation 620, 724).

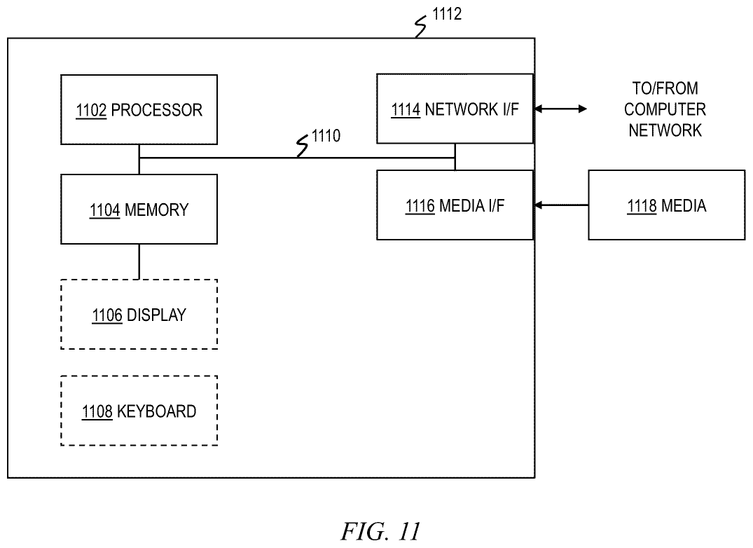

One or more embodiments can make use of software running on a computer. With reference to FIG. 11, such an implementation might employ, for example, a processor 1102, a memory 1104, and an input/output interface formed, for example, by a display 1106 and a keyboard 1108. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 1102, memory 1104, and input/output interface such as display 1106 and keyboard 1108 can be interconnected, for example, via bus 1110 as part of a data processing unit 1112. Suitable interconnections, for example via bus 1110, can also be provided to a network interface 1114, such as a network card, which can be provided to interface with a computer network, and to a media interface 1116, such as a diskette or CD-ROM drive, which can be provided to interface with media 1118 (a USB port interfacing with a so-called “thumb” drive is another example).

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

As used herein, including the claims, a “server” includes a physical data processing system (for example, system 1112 as shown in FIG. 11) running a server program. It will be understood that such a physical server may or may not include a display and keyboard.

It should be noted that any of the methods described herein can include an additional step of providing a system comprising distinct software modules embodied on a computer readable storage medium; the modules can include, for example, any or all of the elements depicted in the block diagrams and/or described herein. The method steps can then be carried out using the distinct software modules and/or sub-modules of the system, as described above, executing on one or more hardware processors 1102. Further, a computer program product can include a computer-readable storage medium (e.g., tangible and non-transitory) with code adapted to be implemented to carry out one or more method steps described herein, including the provision of the system with the distinct software modules.

In any case, it should be understood that the components illustrated herein may be implemented in various forms of hardware, software, or combinations of hardware and software. Application specific integrated circuit(s) (ASICS), field-programmable gate arrays (FPGAs), functional circuitry, one or more appropriately programmed general purpose digital computers with associated memory, and the like, are all examples.

Given the teachings of the invention provided herein, one of ordinary skill in the related art will be able to contemplate other implementations.

Although illustrative embodiments of the invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for processing rebates on a supply chain processing system based on a blockchain architecture, comprising:
instantiating an inventory blockchain that supports multiple entities of the supply chain processing system;
determining, in response to a change in a ledger block of a transaction ledger blockchain, an on-hand inventory for a given item identifier based on a reported sales history and an inventory block comprising inventory metadata that describes a temporal snapshot of the on-hand inventory;
determining a unit and cost allocation of the on-hand inventory using the inventory metadata;
determining a true acquisition cost for the given item identifier based on the inventory metadata of the inventory block and the determined allocation;
determining a special price agreement cost based on a special price agreement block, the special price agreement block comprising terms of a special price agreement;
calculating a rebate amount corresponding to the given item identifier based on the special price agreement cost and the true acquisition cost;
determining a total rebate based on the rebate amount and a sales quantity corresponding to the given item identifier;
generating another inventory block based on a revised inventory; and
updating a rebate blockchain based on the determined total rebate.

2. The method of claim 1, wherein the determining the allocation of the on-hand inventory further comprises merging the reported sales history with purchase orders of a manufacturer/vendor based on a first-in, first-out methodology.

3. The method of claim 1, further comprising:
comparing the total rebate and a submitted rebate claim; and
reporting rebate calculation steps between the total rebate and the submitted rebate claim via a block of the rebate blockchain.

4. The method of claim 1, further comprising:
repeating one or more of the determining and calculating operations;
detecting one or more deviations that necessitate aborting the processing of rebates; and
reporting the deviations via a block of the rebate blockchain.

5. The method of claim 1, further comprising:
determining whether the special price agreement is valid on a given order date by examining an original special price agreement and any subsequent changes to the special price agreement as defined in the special price agreement blockchain;
determining whether at least one of an end-customer and a branch of a distributor 212 are listed on the special price agreement based on the given order date;
determining whether a stock keeping unit is covered by the special price agreement on the given order date;
determining a validity of at least one of an agreed-upon multiplier and a net price for the stock keeping unit on the given order date;
determining a list price for the stock keeping unit corresponding to the given order date; and
determining at least one of an into-stock cost and a true acquisition cost for the distributor on the given order date.

6. The method of claim 1, further comprising:
accessing the calculation steps of the rebate process via the rebate blockchain;
generating a rebate claim report; and
providing the rebate claim report via a rebate processing computerized, code-implemented contract.

7. The method of claim 1, further comprising:
obtaining a request to originate the special price agreement from a special price agreement requestor;
establishing, by a special price agreement origination computerized, code-implemented contract, the special price agreement blockchain corresponding to the special price agreement;
determining, by the special price agreement origination computerized, code-implemented contract, whether the special price agreement requestor has omitted information needed by the special price agreement origination computerized, code-implemented contract;
adding a block to the special price agreement blockchain, the block comprising requestor information;
obtaining a special price agreement approval from a special price agreement requestee via an approval block of the blockchain; and
adding a special price agreement terms block to the special price agreement blockchain.

8. The method of claim 7, further comprising obtaining an assigned special price agreement reference number from the special price agreement requestee and wherein the special price agreement blockchain comprises the assigned special price agreement reference number.

9. The method of claim 7, wherein the requestor information comprises terms of a special price agreement offer.

10. The method of claim 7, further comprising:
obtaining a counter-offer from the special price agreement requestee; and
obtaining an acceptance of the counter-offer by the special price agreement requester.

11. The method of claim 1, further comprising accessing ledger data via a corresponding blockchain;
generating a ledger report; and
providing the ledger report via the special price agreement origination computerized, code-implemented contract.

12. The method of claim 1, further comprising controlling access by a specified entity to specified data of at least one of the rebate blockchain and the transaction ledger blockchain based on one or more access rules.

13. The method of claim 12, wherein at least one access rule is based on one or more of: enabling access by all entities specified on the corresponding special price agreement, enabling access by all entities specified in an access profile, blocking access by all entities absent from a list of enabled entities in the access profile, and blocking access by all entities absent from the corresponding special price agreement.

14. The method of claim 7, further comprising:
searching for blocks in a special price agreement blockchain that comprise original terms of the special price agreement and modified terms of the special price agreement;
obtaining the original terms and the modified terms corresponding to the searched blocks;
generating a summary of terms of the special price agreement valid for a specified date, the summary of terms excluding expired terms of the special price agreement; and
providing the summary of terms via the special price agreement origination computerized, code-implemented contract.

15. The method of claim 1, further comprising:
parsing a file-based special pricing agreement in a non-blockchain format;
filtering data of the non-blockchain format in accordance with terms of an inventory allocation and cost system of the supply chain processing system;
processing the filtered data; and
storing the processed data in one or more blocks of the special price agreement blockchain.

16. The method of claim 15, further comprising loading inventory and sales data in one or more additional blocks of at least one of the special price agreement blockchain and the transaction ledger blockchain.

17. The method of claim 1, further comprising:
obtaining a registration application to register with the supply chain processing system from a registration requester;
creating, by a registration computerized, code-implemented contract, a registration blockchain based on the registration application submitted by the registration requester;
pre-processing the registration application to format registration data of the registration application for entry in a registration database and a participant directory of the supply chain processing system;
updating the registration database and the participant directory to reflect a registration of the registration requester; and
acknowledging acceptance of the registration request to the registration requester via the registration blockchain.

18. The method of claim 17, further comprising:
determining if registration data required by the registration computerized, code-implemented contract is verified and present; and
requesting and obtaining at least one of invalid data and missing data in response to determining that the registration data is not verified and present.

19. The method of claim 17, wherein the participant directory comprises a proper subset of registered participants.

20. A method comprising:
instantiating one or more transaction ledger blockchains that support multiple entities;
accessing an enterprise system of one of the multiple entities to retrieve special price agreement participant data designated for blockchain entry;
validating the accessed data designated for the blockchain entry;
identifying a transaction ledger blockchain of the one or more transaction ledger blockchains for entry of the validated data;
pre-processing the validated data, the pre-processing comprising formatting the validated data for entry in a ledger block of the identified transaction ledger blockchain with a timestamp corresponding to the accessed data; and
populating the pre-processed data into the ledger block of the identified transaction ledger blockchain.

21. The method of claim 20, wherein the special price agreement participant data comprises a sales history for a given stock keeping unit and an identification of on-hand inventory corresponding to the given stock keeping unit for an inventory allocation and cost system to use to allocate distributor inventory.

22. The method of claim 20, wherein additional ledger blocks are at least one of populated periodically, populated when items are sold from an inventory of a distributor, and populated upon an executed sale corresponding to a purchase order.

23. The method of claim 20, wherein the identified transaction ledger blockchain is at least one of a blockchain corresponding to a special price agreement covering the special price agreement participant data, a blockchain dedicated to a manufacturer associated with the special price agreement participant data, a blockchain dedicated to a distributor associated with the special price agreement participant data, a blockchain dedicated to a set of manufacturers, and a blockchain dedicated to a set of distributors.

24. The method of claim 20, wherein the pre-processing further comprises segregating data that references items corresponding to a plurality of the entities in accordance with the corresponding entity and wherein the populating of the pre-processed data into the ledger block populates the segregated data into corresponding segregated blocks, each segregated block corresponding to one of the plurality of entities.

25. The method of claim 20, further comprising:
generating inventory metadata based on at least one of purchase order information and sales order information, the inventory metadata indicating a size of each inventory bin and an into-stock cost for each inventory bin; and
creating an inventory block based on the inventory metadata.

26. A non-transitory computer readable medium comprising computer executable instructions which when executed by a computer cause the computer to perform a method for processing rebates on a supply chain processing system based on a blockchain architecture, the method comprising the operations of:
instantiating an inventory blockchain that supports multiple entities of the supply chain processing system;
determining, in response to a change in a ledger block of a transaction ledger blockchain, an on-hand inventory for a given item identifier based on a reported sales history and an inventory block comprising inventory metadata that describes a temporal snapshot of the on-hand inventory;
determining a unit and cost allocation of the on-hand inventory using the inventory metadata;
determining a true acquisition cost for the given item identifier based on the inventory metadata of the inventory block and the determined allocation;
determining a special price agreement cost based on a special price agreement block, the SPA block comprising terms of a special price agreement;
calculating a rebate amount corresponding to the given item identifier based on the special price agreement cost and the true acquisition cost;
determining a total rebate based on the rebate amount and a sales quantity corresponding to the given item identifier;
generating another inventory block based on a revised inventory; and
updating a rebate blockchain based on the determined total rebate.

27. A non-transitory computer readable medium comprising computer executable instructions which when executed by a computer cause the computer to perform the method of:
instantiating one or more transaction ledger blockchains that support multiple entities;
accessing an enterprise system of one of the multiple entities to retrieve special price agreement participant data designated for blockchain entry;
validating the accessed data designated for the blockchain entry;
identifying a transaction ledger blockchain of the one or more transaction ledger blockchains for entry of the validated data;
pre-processing the validated data, the pre-processing comprising formatting the validated data for entry in a ledger block of the identified transaction ledger blockchain with a timestamp corresponding to the accessed data; and
populating the pre-processed data into the ledger block of the identified transaction ledger blockchain.

28. An apparatus comprising:
a memory; and
at least one processor, coupled to said memory, and operative to perform a method for processing rebates on a supply chain processing system based on a blockchain architecture, the method comprising operations of:
instantiating an inventory blockchain that supports multiple entities of the supply chain processing system;
determining, in response to a change in a ledger block of a transaction ledger blockchain, an on-hand inventory for a given item identifier based on a reported sales history and an inventory block comprising inventory metadata that describes a temporal snapshot of the on-hand inventory;
determining a unit and cost allocation of the on-hand inventory using the inventory metadata;
determining a true acquisition cost for the given item identifier based on the inventory metadata of the inventory block and the determined allocation;
determining a special price agreement cost based on a special price agreement block, the SPA block comprising terms of a special price agreement;
calculating a rebate amount corresponding to the given item identifier based on the special price agreement cost and the true acquisition cost;
determining a total rebate based on the rebate amount and a sales quantity corresponding to the given item identifier;
generating another inventory block based on a revised inventory; and
updating a rebate blockchain based on the determined total rebate.

29. An apparatus comprising:
a memory; and
at least one processor, coupled to said memory, and operative to perform operations comprising:
instantiating one or more transaction ledger blockchains that support multiple entities;
accessing an enterprise system of one of the multiple entities to retrieve special price agreement participant data designated for blockchain entry;
validating the accessed data designated for the blockchain entry;
identifying a transaction ledger blockchain of the one or more transaction ledger blockchains for entry of the validated data;
pre-processing the validated data, the pre-processing comprising formatting the validated data for entry in a ledger block of the identified transaction ledger blockchain with a timestamp corresponding to the accessed data; and
populating the pre-processed data into the ledger block of the identified transaction ledger blockchain.
